(19) United States
(12) Patent Application Publication
(10) Pub. No.: US 2024/0281594 A1
(43) Pub. Date: Aug. 22, 2024

(54) ARTIFICIAL INTELLIGENCE ASSISTED EDITING

(71) Applicant: Abridge AI, Inc., Pittsburgh, PA (US)

(72) Inventors: Shivdev Rao, Pittsburgh, PA (US); Sandeep Konam, Pittsburgh, PA (US)

(21) Appl. No.: 18/443,847

(22) Filed: Feb. 16, 2024

Related U.S. Application Data
(60) Provisional application No. 63/447,421, filed on Feb. 22, 2023.

(51) Int. Cl. G06F 40/166; G06F 3/04842

(52) U.S. Cl. CPC G06F 40/166; G06F 3/04842

(57) ABSTRACT

Artificial intelligence assisted editing may be provided by providing, via a Graphical User Interface (GUI), a transcript of a natural language conversation and a summary of the natural language conversation based on the transcript generated by a machine learning model; in response to receiving user selection of a selected phrase in the transcript or summary, providing an edit interface in the GUI; querying the machine learning model for a suggested phrase to replace the selected phrase with; and populating the edit interface with the suggested phrase.

### BACKGROUND

Machine Learning (ML) is a branch of Artificial Intelligence (AI) directed to developing AI models that continuously improve or “learn” based on training data to make predictions (and take corresponding actions) on new data. Machine Learning Models (MLM) are used in a variety of applications, including in Natural Language Processing (NLP) for computer systems to understand freeform text and spoken words. Human speech, despite various grammatical rules, is generally unstructured, as there are myriad ways for a human to express one concept using natural language. Accordingly, processing human speech into a structured format usable by computing systems is a complex task for NLP systems to perform, and one that calls for great accuracy if the output for the NLP systems is to be trusted by human users for sensitive tasks.

### SUMMARY

The present disclosure is generally related to Artificial Intelligence (AI) and User Interface (UI) design and implementation useful for automatically completing, or suggesting for completion, for entry and editing of natural language text.

The present disclosure provides methods and apparatuses (including systems and computer-readable storage media) to interact with various Machine Learning Models (MLM) trained to convert spoken utterances to written transcripts and summaries of those transcripts as part of a Natural Language Processing (NLP) system. As an MLM is only as accurate as the training data used to teach that MLM, a human in the loop (HIL) or end user may need to edit the output of the MLM before the output can be used in a sensitive task, or the MLM is retrained.

Although various editing tools (e.g., spellcheck, predictive text) are available to human authors in various word processing applications, in the context of editing transcripts generated by MLMs, these tools may not offer appropriate or useful assistance to the annotator or may be disabled for data security reasons. For example, a transcript generated by an MLM is generally less likely to contain spelling errors compared to containing (correctly spelled) misidentified words from a spoken natural language conversation. Accordingly, various UIs are provided to annotators to prompt for the entry of text that the MLM has not (or cannot) confidently output from spoken language audio data, or to edit the output generated by the MLM for spoken language audio data.

In some embodiments, the editing assistance offered by these UIs uses the MLM's confidence rankings for potential outputs, to allow an annotator to select a candidate output evaluated by the MLM to represent the audio data, but that was not initially selected by the MLM to represent the spoken conversation, to replace the candidate output that was initially selected by the MLM. For example, when an NLP system identifies a spoken term to be either “taste taker” or “pacemaker”, and selects “taste taker” as having a higher confidence of representing the utterance, the UI may present an annotator with the option to replace the first candidate transcription (e.g., “taste taker”) with the second (and subsequent) candidate transcriptions (e.g., “pacemaker”) in addition to, or alternatively to, suggestions based on similar spellings (e.g., “taste tamer”), similar sounds (e.g., “testicular”), or prior occurrences of a term/entry of a term (e.g., “taste bud”).

In some embodiments, the editing assistance offered by these UIs is based on generalized evidence from the transcript (rather than prior text entry history). For example, due to privacy concerns, the editing application may be prohibited from learning data entry history or drawing parallels in speech patterns between different conversations, and instead offers suggested based on other phrases in the current transcript. For example, although a predictive text algorithm may learn an association between term A and term B to recommend entry of term B after entry of term A is detected, some example UIs may present detected pairing from elsewhere in the transcript, which may be order independent. Accordingly, when the phrase “adjust pacemaker voltage” appears in the transcript and the user selects an instance of the phrase “pacemaker” elsewhere in the transcript, the UI may suggest “adjust pacemaker”, “pacemaker voltage”, and “adjust pacemaker voltage” as suggested phrases to the annotator. Additionally or alternatively, the UI may select a larger phrase when a user has selected a smaller phrase when another instance of the larger phrase exists in the transcript, such as when the user selects the element “pacemaker” in an instance of the phrase “adjust pacemaker voltage” so that the UI selects the repeated phrase “adjust pacemaker voltage” on behalf of the user for editing.

In some embodiments, the editing assistance offered by the UIs is based on correcting the reasoning of the MLM using selected evidence from the transcript, which can include providing alternative evidence from the transcript to prompt the MLM to re-generate a portion of the output. For example, when the MLM generates a summary of the transcript which states “Patient Taking Vitamin D; Daily”, and the annotator selects a portion of the transcript as evidence that the patient is not taking vitamin D daily, the annotator may correct the summary without correcting the transcript, and update any metadata links between the summary and the transcript to link to the correct evidence.

In some embodiments, the editing assistance offered by these UIs is the regeneration of AI-generated output based on edited text. For example, after correcting the text of a transcript that the MLM consumes to produce a summary of the transcript or updating what subset of the text that the MLM should consume as evidence, the annotator may request or be prompted to accept a revised summary for the transcript that is generated by the MLM, rather than manually entering a new summary to correctly reflect the contents of the transcript.

Accordingly, the present disclosure is generally directed to increasing and improving the functionality, efficiency, and usability of the underlying computing systems and MLMs via the various methods and apparatuses described herein via an improved UI.

One embodiment of the present disclosure is a method of performing operations, a system including a processor and a memory that includes instructions that when executed by the processor performs operations, or a computer readable storage device that including instructions that when executed by a processor perform operations, wherein the operations comprise: providing, via a graphical user interface (GUI), a transcript of a natural language conversation and a summary of the natural language conversation based on the transcript generated by a machine learning model; in response to user selection of a selected phrase in the transcript, providing an edit interface in the GUI; querying the machine learning model for a suggested phrase to replace the selected phrase with in the transcript; and populating the edit interface with the suggested phrase.

One embodiment of the present disclosure is a method of performing operations, a system including a processor and a memory that includes instructions that when executed by the processor performs operations, or a computer readable storage device that including instructions that when executed by a processor perform operations, wherein the operations comprise: providing, via a graphical user interface (GUI), a transcript of a natural language conversation and a summary of the natural language conversation based on the transcript generated by a machine learning model; in response to user selection of a selected phrase in the summary, providing an edit interface in the GUI; querying the machine learning model for a suggested phrase to replace the selected phrase; and populating the edit interface with the suggested phrase.

One embodiment of the present disclosure is a method of performing operations, a system including a processor and a memory that includes instructions that when executed by the processor performs operations, or a computer readable storage device that including instructions that when executed by a processor perform operations, wherein the operations comprise: providing, via a graphical user interface (GUI), a transcript and a summary of a natural language conversation based on the transcript generated by a machine learning model; in response to user selection of a selected phrase in one of the transcript and the summary, providing an edit interface in the GUI; receiving, via the edit interface, a replacement phrase for the selected phrase in the one of the transcript and the summary; replacing the selected phrase with the replacement phrase in the one of the transcript and the summary; identifying any additional instances of the selected phrase in the transcript and the summary; querying the machine learning model for downstream phrases in the transcript and the summary that used the selected phrase as an input; and in response to there being at least one additional instance or downstream phrase, updating the GUI to highlight the at least one of the additional instances and the downstream phrases.

### BRIEF DESCRIPTION OF THE DRAWINGS

The accompanying figures depict various elements of the one or more embodiments of the present disclosure, and are not considered limiting of the scope of the present disclosure.

In the Figures, some elements may be shown not to scale with other elements so as to more clearly show the details. Additionally, like reference numbers are used, where possible, to indicate like elements throughout the several Figures.

It is contemplated that elements and features of one embodiment may be beneficially incorporated in the other embodiments without further recitation or illustration. For example, as the Figures may show alternative views and time periods, various elements shown in a first Figure may be omitted from the illustration shown in a corresponding second Figure without disclaiming the inclusion of those elements in the embodiments illustrated or discussed in relation to the second Figure.

FIG. 1 illustrates an example environment that an annotating user interface can be provided, according to embodiments of the present disclosure.

FIG. 2 illustrates a computing environment, according to embodiments of the present disclosure.

FIGS. 3A-3H illustrate interactions with user interfaces for an annotator showing an editing process for a transcript of a conversation, according to embodiments of the present disclosure.

FIGS. 4A-4H illustrate interactions with user interfaces for an annotator showing an editing process for a summary of a transcript of a conversation, according to embodiments of the present disclosure.

FIG. 5 is a flowchart of a method for providing annotation user interfaces, according to embodiments of the present disclosure.

FIG. 6 is a flowchart of a method for providing annotation user interfaces, according to embodiments of the present disclosure.

FIG. 7 illustrates physical components of a computing device, according to embodiments of the present disclosure.

### DETAILED DESCRIPTION

Because transcripts of spoken conversations are becoming increasingly important in a variety of fields, the accuracy of those transcripts and the interpreted elements extracted from those transcripts is also increasing in importance. Accordingly, accuracy in the transcript affects the accuracy in the later analyses, and greater accuracy in transcription and analysis improves the usefulness of the underlying systems used to generate the transcript and analyses thereof.

To create these transcripts and the analyses thereof, the present disclosure describes a Natural Language Processing (NLP) system. As used herein, NLP is the technical field for the interaction between computing devices and unstructured human language for the computing devices to be able to “understand” the contents of the conversation and react accordingly. An NLP system may be divided into a Speech Recognition (SR) system, that generates a transcript from a spoken conversation, and an analysis system, that extracts semantic information from the written record, such as summaries of the transcript as a whole or other points of interest from sub-sections of the transcript. In various embodiments, the NLP system may use separate Machine Learning Models (MLMs) for each of the SR system and the analysis system, or may use one MLM to handle the SR tasks and the analysis tasks.

When reviewing the output of the NLP system, an annotator may wish to correct or make notes related to the transcript or the summary (generally referred to as edits). These edits may be added to the transcript and summary for an end user as annotations to the original output, or may replace portions of the original output. When making these edits, the annotator may update the MLMs used by the NLP with the corrections or notes made by the annotator to thereby provide feedback to retrain the MLM. Additionally or alternatively, these edits can also be used to request suggestions for how to next edit the transcript and summary. Various example UIs are described herein to improve the editing process to not only change portions of the transcript and summary, but to serve as an interface between the MLM and the annotator in order to provide the annotator with MLM-augmented suggestions (based on the feedback or initial edits from the annotator) for the annotator to choose from when editing the transcript or summary.

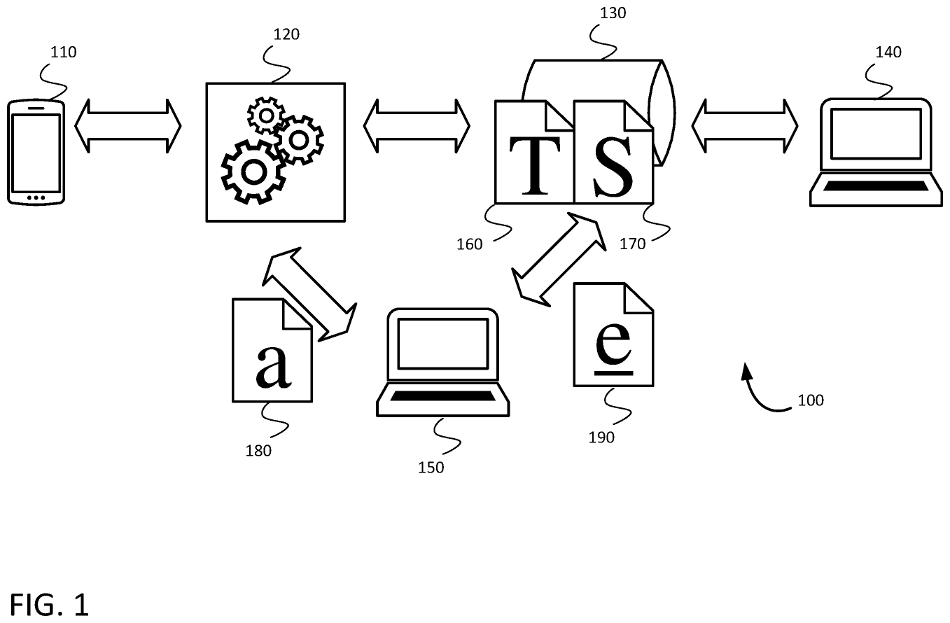

FIG. 1 illustrates an example environment 100 in which an annotating User Interface (UI) can be provided, according to embodiments of the present disclosure. A shown in FIG. 1, a recording device 110 in in communication with an NLP system 120 to convert a spoken natural language conversation captured by the recording device 110 into a transcript 160 and various associated summaries 170 of the transcript 160, which are stored in a database 130.

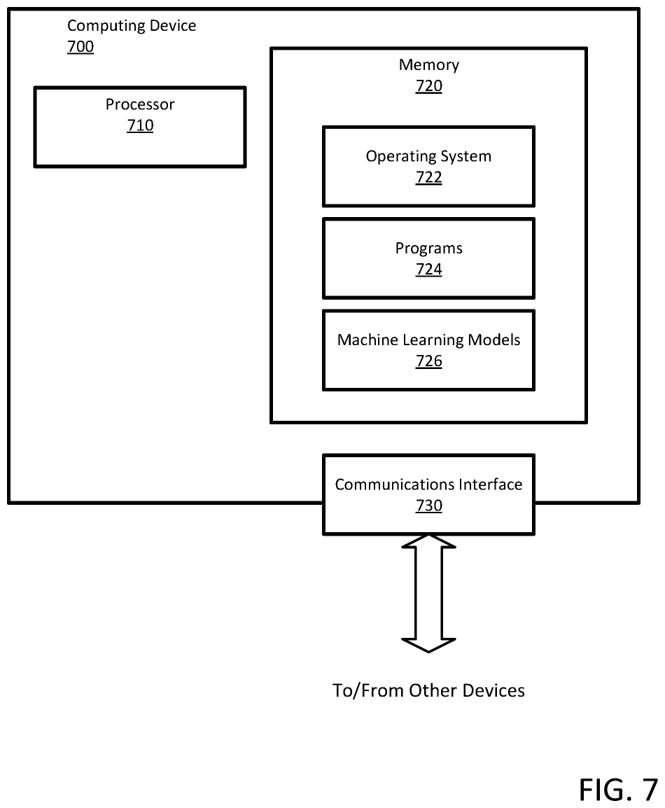

In various embodiments, the recording devices 110 may be any device (e.g., such as the computing device 700 described in relation to FIG. 7) that is capable of recording the audio of the conversation, which may include cellphones, dictation devices, laptops, tablets, personal assistant devices, or the like. In various embodiments, the recording device 110 may transmit the conversation according to various file formats (e.g., WAV, AIFF, FLAC, ATRAC, ALC, WMA, etc.) for processing to a remote service (e.g., via a telephone or data network), locally store or cache the recording of the conversation for later processing (locally or remotely), or combinations thereof. In various embodiments, the recording device 110 may pre-process the recording of the conversation to remove or filter out environmental noise, compress the audio, remove undesired sections of the conversation (e.g., silences or user-indicated portions to remove), which may reduce data transmission loads or otherwise increase the speed of transmission of the conversation over a network.

In various embodiments, the transcripts 160 and summaries 170 may be provided to a consuming device 140 for an end user to consume the transcript 160 and summaries 170, and to an annotating device 150 for an annotating user (e.g., an annotator) to review and edit the transcript 160 or summary 170. In addition to receiving the transcripts 160 and summaries 170 from the database 130, the annotating device 150 is also in communication with the NLP system 120 to send and receive annotations 180 to improve the annotator's ability to make edits 190 to the transcripts 160 and summaries 170 stored in the database 130. In various embodiments, the consuming device 140 and the annotating device 150 may be different devices used by different users, the same device used by the same users but in different modes, and variations thereof. In various embodiments, the consuming device 140 and the annotating device 150 may be any device (e.g., such as the computing device 700 described in relation to FIG. 7) that is capable of sending and receiving digital files for reading/playback and manipulating (e.g., editing) those digital files, which may include cellphones, dictation devices, laptops, tablets, personal assistant devices, or the like.

Recording and transcribing conversations related to healthcare, technology, academia, or various other esoteric topics can be particularly challenging for NLP systems 120 due to the low number of example utterances that include related terms, the inclusion of jargon and shorthand used in the particular domain, the similarities in phonetics of markedly different terms within the domain (e.g., lactase vs. lactose), similar terms having certain meanings inside of the domain that are different from or more specific than the meanings used outside of the domain, mispronunciation or misuse of domain terms by non-experts speaking to domain experts, and other challenges. Accordingly, the annotating device 150 is provided, in some instances, to a human user acting as a Human-in-the-Loop (HiL) or reviewer to provide corrections, notes, suggesting, and feedback to the machine learning models (MLMs) used by the NLP system 120 and to correct any errors or note any ambiguities in the transcripts 160 and summaries 170.

The present disclosure therefore provides for UIs that allow annotators to more readily interact with the transcripts 160 and summaries 170 and to expose various processes of the NLP systems 120 and MLMs that produced the transcripts 160 or summaries 170. The annotator is also enabled to use the NLP systems 120 and MLMs thereof as an editing tool for the specified context of a transcript 160 or summary 170 currently being annotated, rather than a generalized context for all transcripts/summaries produced by the NLP system 120 or annotated previously by the annotating device 140, thereby improving data privacy for the annotation process.

Although the present disclosure primarily uses example conversations related to a healthcare visit as a basis for the examples discussed herein, the present disclosure may be used for the provision and manipulation of data gleaned from conversations related to various topics outside of the healthcare space (e.g., equipment maintenance, education, law, agriculture, etc.). Additionally, although the example conversations and analyzed terms discussed herein are primarily provided in English, the present disclosure may be applied for transcribing and annotating a variety of languages with different vocabularies, grammatical rules, word-formation rules, and use of tone to convey complex semantic meanings and relationships between words.

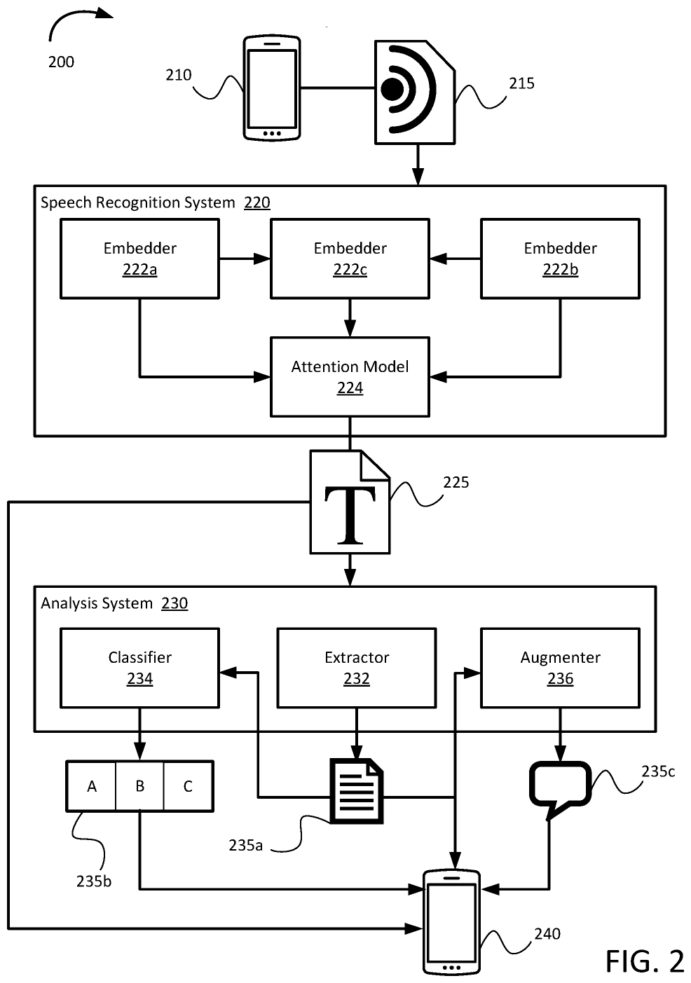

FIG. 2 illustrates a computing environment 200, according to embodiments of the present disclosure. The computing environment 200 may represent a distributed computing environment that includes multiple computers, such as the computing device 700 discussed in relation to FIG. 7, interacting to provide different elements of the computing environment 200 or may include a single computer that locally provides the different elements of the computing environment 200. Accordingly, some or all of the elements illustrated with a single reference number or object in FIG. 2 may include several instances of that element, and individual elements illustrated with one reference number or object may be performed partially or in parallel by multiple computing devices.

The computing environment 200 includes an audio provider 210, such as a recording device 110 described in relation to FIG. 1, that provides a recording 215 of a completed conversation or individual utterances of an ongoing conversation to a Speech Recognition (SR) system 220 to identify the various words and intents within the conversation. The SR system 220 provides a transcript 225 of the recording 215 to an analysis system 230 to identify and analyze various aspects of the conversation relevant to the participants. As used herein, the SR system 220 and the analysis system 230 may be jointly referred to as an NLP system.

As received, the recording 215 may include an audio file of the conversation, video data associated with the audio data (e.g., a video recording of the conversation vs. an audio-only recording), as well as various metadata related to the conversation, and may also include video data. For example, a user account associated with the audio provider 210 may serve to identify one or more of the participants in the conversation, or append metadata related to the participants. For example, when a recording 215 is received from an audio provider 210 associated with John Doe, the recording 215 may include metadata that John Doe is a participant in the conversation. The user of the audio provider 210 may also indicate that the conversation took place with Erika Mustermann, (e.g., to provide the identity of another speaker not associated with the audio provider 210), when the conversation took place, whether the conversation is complete or is ongoing, where the conversation took place, what the conversation concerns, or the like.

The SR system 220 receives the recording 215 and processes the recording 215 via various machine learning models to convert the spoken conversation into various words in textual form. The models may be domain specific (e.g., trained on a corpus of words for a particular technical field) or general purpose (e.g., trained on a corpus of words for general speech patterns). In various embodiments, the SR system 220 may use an Embedding from Language Models (ELMo) model or a Bidirectional Encoder Representation from Transformers (BERT) model or other machine learning models to convert the natural language spoken audio into a transcribed version of the audio. In various embodiments, the SR system 220 may use Transformer networks, a Connectionist Temporal Classification (CTC) phoneme based model, a Hidden Markov based model, attention based models, a Listen Attend and Spell (LAS) grapheme based model, or any other model to convert the natural language spoken audio into a transcribed version of the audio. In some embodiments, the analysis system 230 may be a large language model.

Converting the spoken utterances to a written transcript not only matches the phonemes to corresponding characters and words, but also uses the syntactical and grammatical relationship between the words to identify a semantic intent of the utterance. The SR system 220 uses this identified semantic intent to select the most correct word in the context of the conversation. For example, the words “there”, “their”, and “they're” all sound identical in most English dialects and accents, but convey different semantic intents, and the SR system 220 selects one of the options for inclusion in the transcript for a given utterance. Accordingly, an attention model 224, is used to provide context of the various different candidate words among each other. The selected attention model 224 can use a Long Short Term Memory (LSTM) architecture to track relevancy of nearby words on the syntactical and grammatical relationships between words at a sentence level or across sentences (e.g., to identify a noun introduced in an earlier utterance related to a pronoun in a later utterance).

The SR system 220 can include one or more embedders 222a-c (generally or collectively embedder 222) to embed further annotations to the transcript 225, such as, for example by including: key term identifiers, timestamps, segment boundaries, speaker identifies, and the like. Each embedder 222 may be a trained MLM to identify various features in the audio recording 215 and/or transcript 225 that are used for further analysis by an attention model 224 or extraction by the analysis system 230.

For example, a first embedder 222a is trained to recognize key terms, and may be provided with a set of words, relations between words, or the like to analyze the transcript 225 for. Key terms may be defined to include various terms (and synonyms) of interest to the users. For example, in a medical domain, the names of various medications, therapies, regimens, syndromes, diseases, symptoms, etc., can be set as key terms. In a maintenance domain, the names of various mechanical or electrical components, assurance tests, completed systems, locational terms, procedures, etc., can be set as key terms. In another example, time based words may be identified as candidate key terms (e.g., Friday, tomorrow, last week). Once recognized in the text of the transcript, a key term embedder 222 may embed a metadata tag to identify the related word or set of words as a key term, which may include tagging pronouns associated with a noun with the same metadata tags as the associated noun.

A second embedder 222b can be used by the SR system 220 to recognize different participants in the conversation. In various embodiments, individual speakers may be distinguished by vocal patterns (e.g., a different fundamental frequency for each speaker's voice), loudness of the utterances (e.g., identifying different locations relative to a recording device), or the like.

In another example, a third embedder 222c is trained to recognize segments within a conversation. In various embodiments, the SR system 220 diarizes the conversation into portions that identify the speaker, and provides punctuation for the resulting sentences (e.g., commas at short pauses, periods at longer pauses, question marks at a longer pause preceded by rising intonation) based on the language being spoken. The third embedder 222c may then add metadata tags for who is speaking a given sentence (as determined by the second embedder 222b) and group one or more portions of the sentence together into segments based on one or more of a shared theme or shared speaker, question breaks in the conversation, time period (e.g., a segment may be between X and Y minutes long before being joined with another segment or broken into multiple segments), or the like.

When using a shared theme to generate segments, the SR system 220 may use some of the key terms identified by a key term embedder 222 via string matching. For each of the detected key terms identifying a theme, the segment identifying embedder 222 selects a set of nearby sentences to group together as a segment. For example, when a first sentence uses a noun, and a second sentence uses a pronoun for that noun, the two sentences may be grouped together as a segment. In another example, when a first person provides a question, and a second person provides a responsive answer to that question, the question and the answer may be grouped together as a segment. In some embodiments, the SR system 220 may define a segment to include between X and Y sentences, where another key term for another segment (and the proximity to the second key term to the first) may define ab edge between adjacent segments.

Once the SR system 220 generates a transcript 225 of the identified words from the recording 215, the SR system 220 provides the transcript 225 to an analysis system 230 to generate various analysis outputs 235 from the conversation. In various embodiments, the operations of the SR system 220 are separately controlled from the operations of the analysis system 230, and the analysis system 230 may therefore operate on a transcript 225 of a written conversation or a human-generated transcript (e.g., omitting the SR system 220 from the NLP system or substituting a non-MLM system for the SR system 220). The SR system 220 may directly transmit the transcript 225 to the output device 240 (before or after the analysis system 230 has analyzed the transcript 225), or the analysis system 230 may transmit the transcript 225 to the output device 240 on behalf of the SR system 220 once analysis is complete.

The analysis system 230 may use an extractor 232 to generate readouts 235a of the key points to provide human-readable summaries of the interactions between the various identified key terms from the transcript. These summaries include the identified key terms (or related synonyms) and are formatted according to factors for sufficiency, minimality, and naturalness. Sufficiency defines a characteristic for a key point that, if given only the annotated span, a reader should be able to predict the correct classification label for the key point, which encourages longer key points that cover all distinguishing or background information needed to interpret the contents of a key point. Minimality defines a characteristic for a key point that identifies peripheral words which can be replaced with other words without changing the classification label for the key point, which discourages marking entire utterances as needed for the interpretation of a key point. Naturalness defines a characteristic for a key point that, if presented to a human reader should sound like a complete phrases in the language used (or as a meaningful word if the key point has only a single key term) to avoid dropping stop words from within phrases and reduce the cognitive load on the human who uses the NLP system's extraction output.

For example, when presented with a series of sentences from the transcript 225 related to how frequently a user should replace a battery in a device, and what type of battery to use, the extractor 232 may analyze several sentences or segments to identify relevant utterances spoken by more than one person to arrive at a summary. The readout 235a may recite “Replace battery; Every year; Use nine volt alkaline” to provide all or most of the relevant information in a human-readable format that was gathered from a much larger conversation.

A category classifier 234 included in the analysis system 230 may operate in conjunction with the extractor 232 to identify various categories 235b that the readouts 235a belong to. In various embodiments, the categories 235b include several different classifications for different users with different review goals for the same conversation. In various embodiments, the category classifier 234 determines the classification based on one or more context vectors developed via the attention model 224 of the SR system 220 to identify whether a given segment or portion of the conversation belongs to which category (including a null category) out of a plurality of potential categories that a user can select from the system to classify portions of the conversation into.

The analysis system 230 may include an augmenter 236 that operates in conjunction with the extractor 232 to develop supplemental content 235c to provide with the transcript 225. In various embodiments, the supplemental content 235c can include callouts of pseudo-key terms based on inferred or omitted details from a conversation, hyperlinks between key points and semantically relevant segments of the transcript, links to (or provides the content for) supplemental or definitional information to display with the transcript, calendar integration with extracted terms, or the like.

For example, when the extractor 232 identifies terms related to a planned follow up conversation (e.g., “I will call you back in thirty minutes”), the augmenter 236 can generate supplemental content 235c that includes a calendar invitation or reminder in a calendar application associated with one or more of the participants that a call is expected thirty minutes from when the conversation took place. Similarly, if the augmenter 236 identifies terms related to a planned follow up conversation that omits temporal information (e.g., “I will call you back”), the augmenter 236 can generate a pseudo-key term to treat the open-ended follow up as though an actual follow up time had been set (e.g., to follow up within a day or set a reminder to provide a more definite follow up time within a system-defined placeholder amount of time).

In various embodiments, when generating supplemental content 235c of a hyperlink between an extracted key point and a segment from the transcript, the augmenter 236 links the most-semantically-relevant segment with the key point, to allow users to navigate to relevant portions of the transcript 225 via the key points. As used herein, the most-semantically-relevant segment refers to the one segment that provides the greatest effect on the category classifier 234 choosing to select one category for the key point, or the one segment that provides the greatest effect on the extractor 232 to identify the key point within the context of the conversation. Stated differently, the most-semantically-relevant segment is the portion of the conversation that has the greatest effect on how the analysis system 230 interprets the meaning and importance of the key point within the conversation.

Additionally, the augmenter 236 may generate or provide supplemental content 235c for defining or explaining various key terms to a reader. For example, links to third-party webpages to explain or provide pictures of various unfamiliar terms, or details recalled from a repository associated with a key term dictionary, can be provided by the augmenter 236 as supplemental content 235c.

The augmenter 236 may format the hyperlink to include the primary target of the linkage (e.g., the most-semantically-relevant segment), various secondary targets to use in updating the linkage based on user feedback (e.g., a next-most-semantically-relevant segment), and various additional effects or content to call based on the formatting guidelines of various programming or markup languages.

Each of the extractor 232, category classifier 234, and the augmenter 236 may be separate MLMs or different layers within one MLM provided by the analysis system 230. Similarly, although illustrated in FIG. 2 with separate modules for an extractor 232, classifier 234, and augmenter 236, in various embodiments, the analysis system 230 may omit one or more of the extractor 232, classifier 234, and augmenter 236 or combine two or more of the extractor 232, classifier 234, and augmenter 236 in a single module. Additionally, the flow of outputs and inputs between the various modules of the analysis system 230 may differ from what is shown in FIG. 2 according to the design of the analysis system 230. When training the one or more MLMs of the analysis system 230, the MLMs may be trained via a first inaccurate supervision technique, such as via fine tuning a large language model, and subsequently by a second incomplete supervision technique to fine-tune the inaccurate supervision technique and thereby avoid catastrophic forgetting. Additional feedback from the user may be used to provide supervised examples for further training of the MLMs and better weighting of the factors used to identify relevancy of various segments of a conversation to the key points therein, and how those key points are to be categorized for review.

The analysis system 230 provides the analysis outputs 235 to an output device 240 for storage or output to a user. In some embodiments, the output device 240 may be the same or a different device from the audio provider 210. For example, a caregiver may record a conversation via a cellphone as the audio provider 210, and receive and interact with the transcript 225 and analysis outputs 235 of the conversation via the cellphone. In another example, the caregiver may record a conversation via a cellphone as the audio provider 210, and receive and interact with the transcript 225 and analysis outputs 235 of the conversation via a laptop computer.

In various embodiments, the output device 240 is part of a cloud storage or networked device that stores the transcript 225 and analysis outputs 235 for access by other devices that supply matching credentials to allow for access on multiple endpoints.

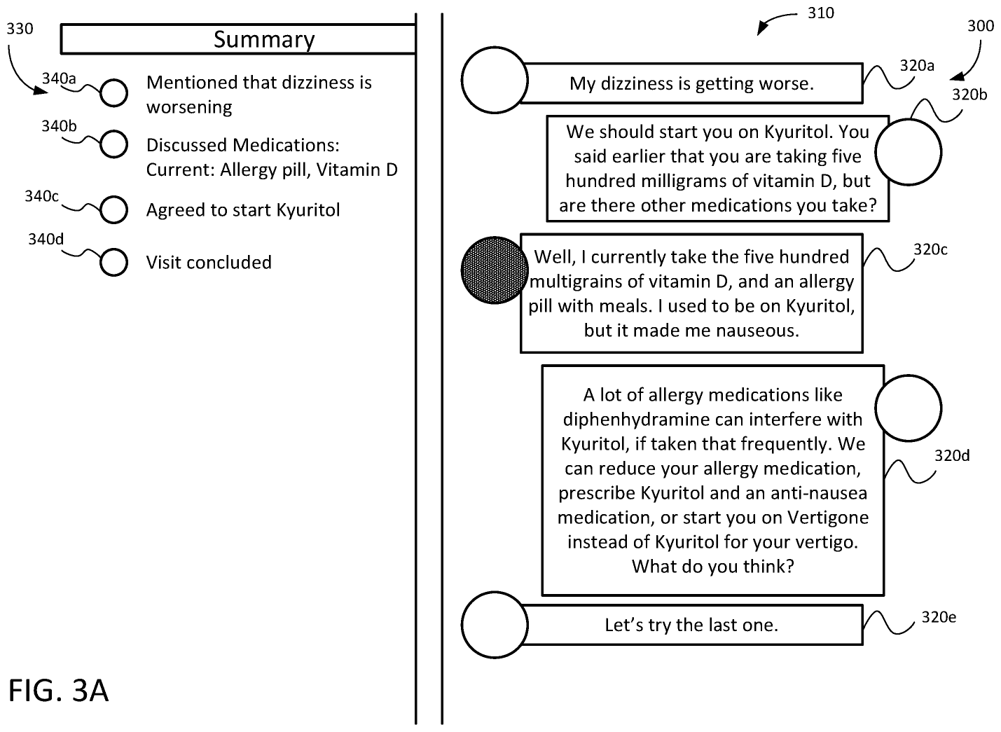

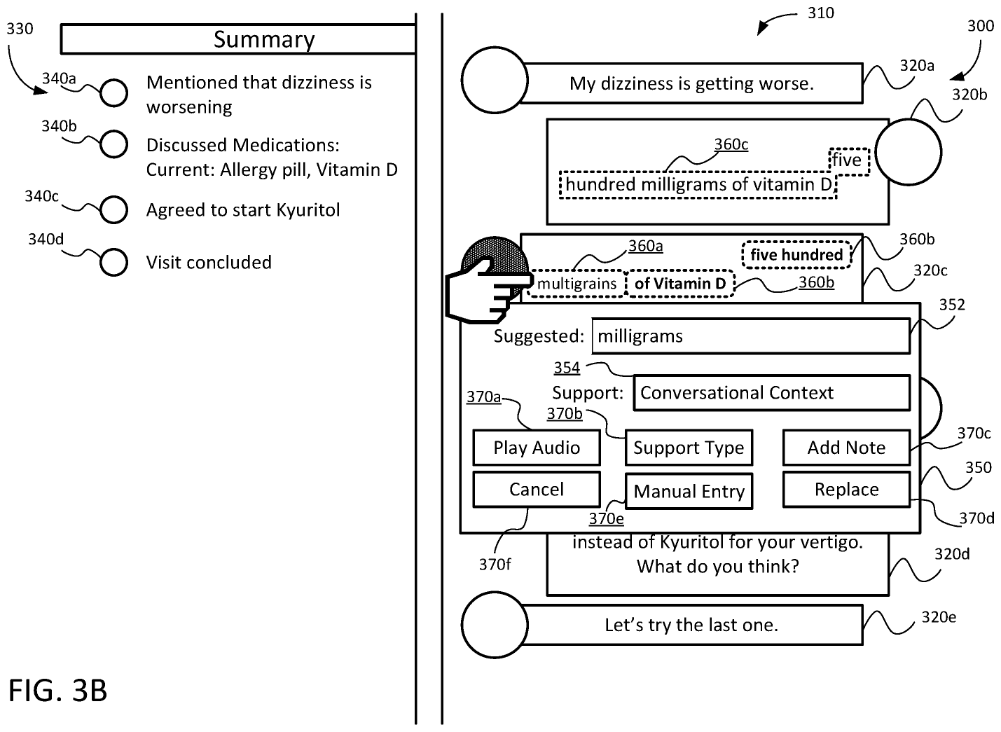

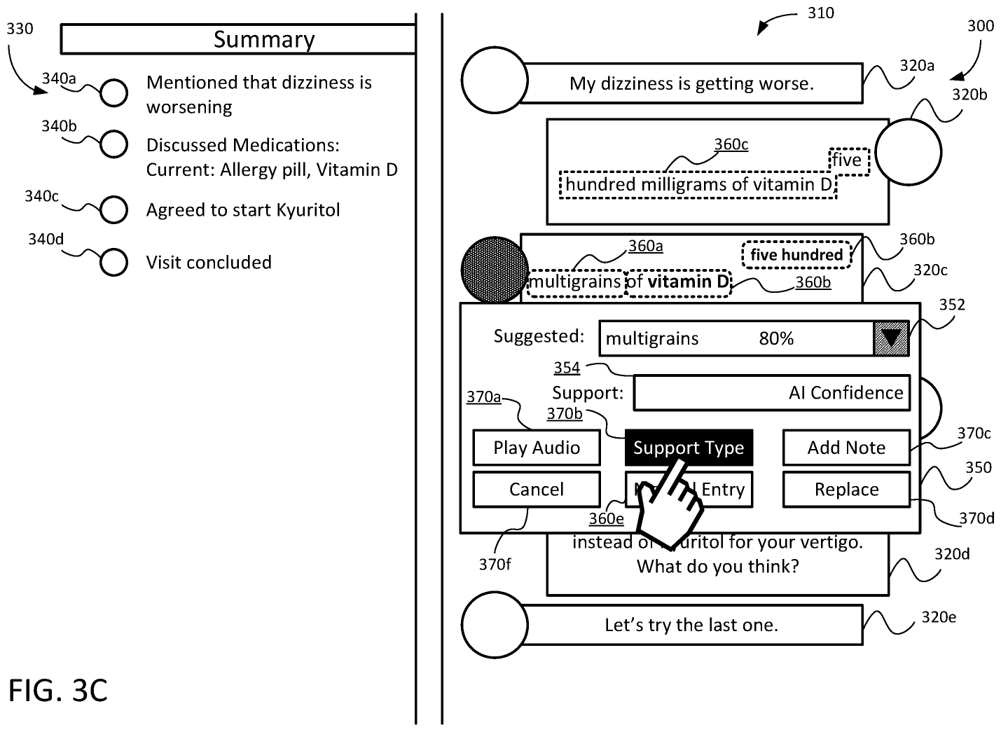

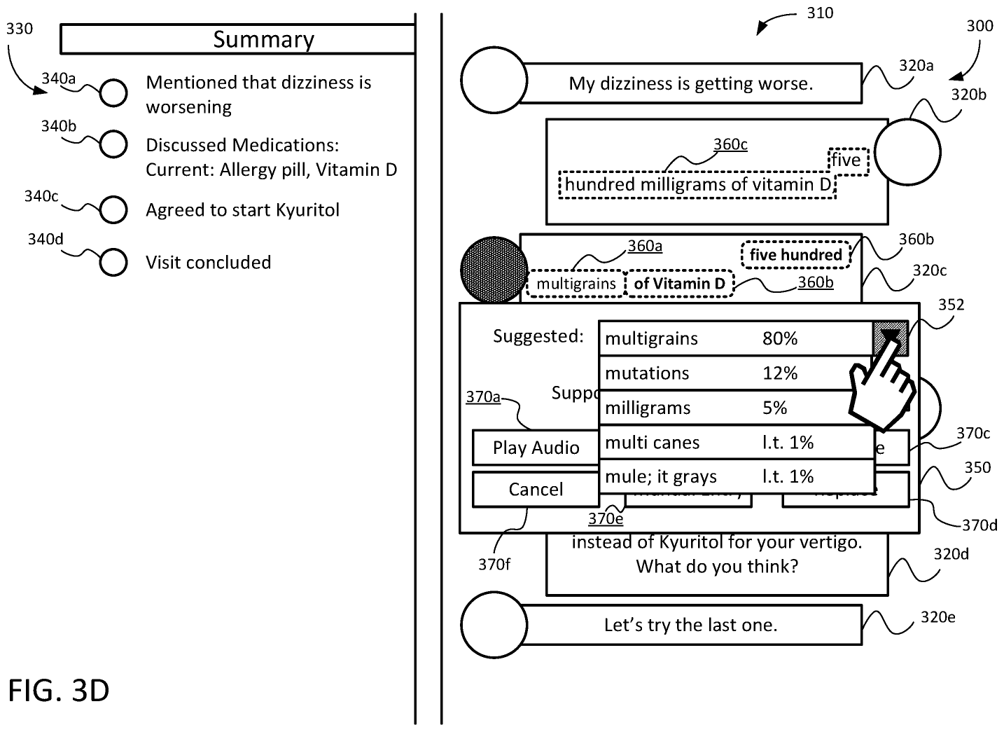

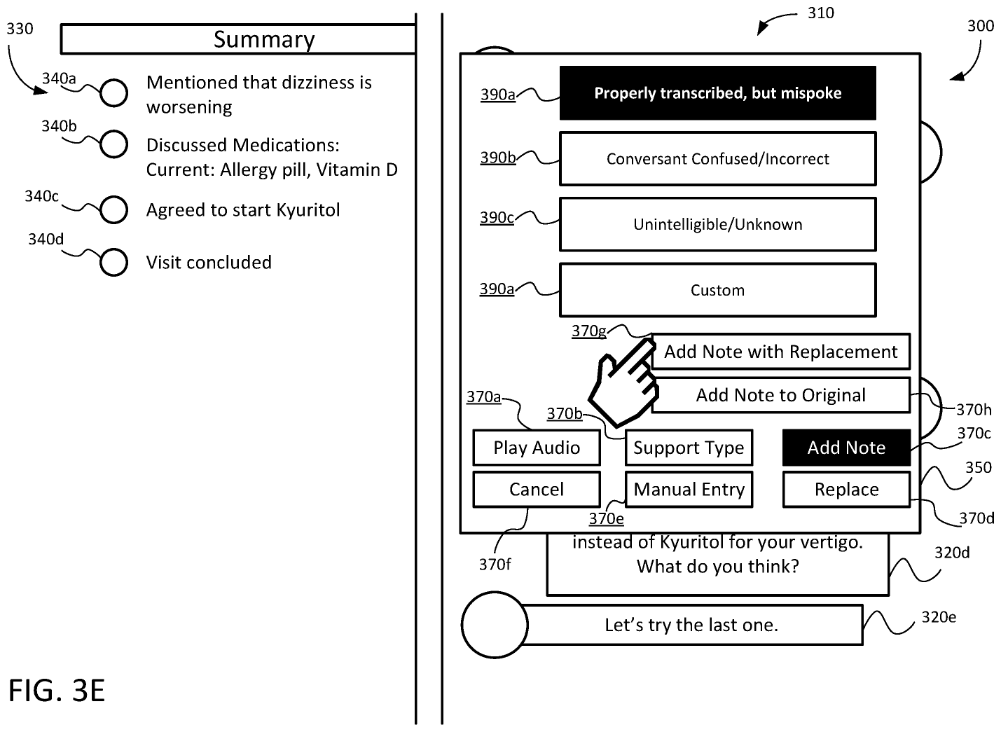

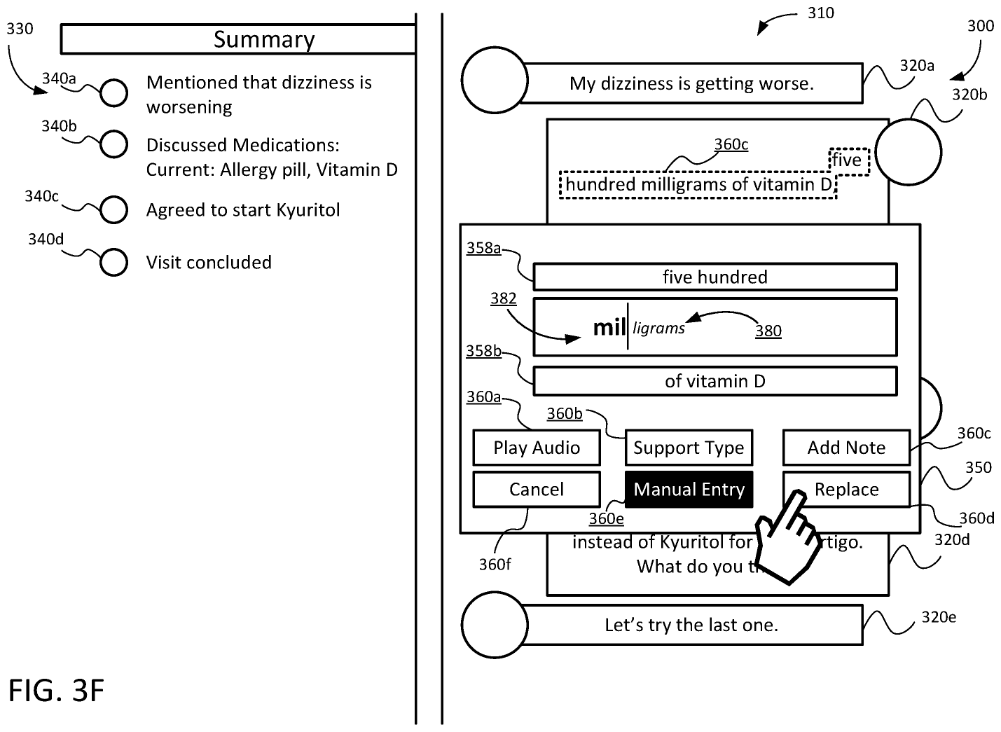

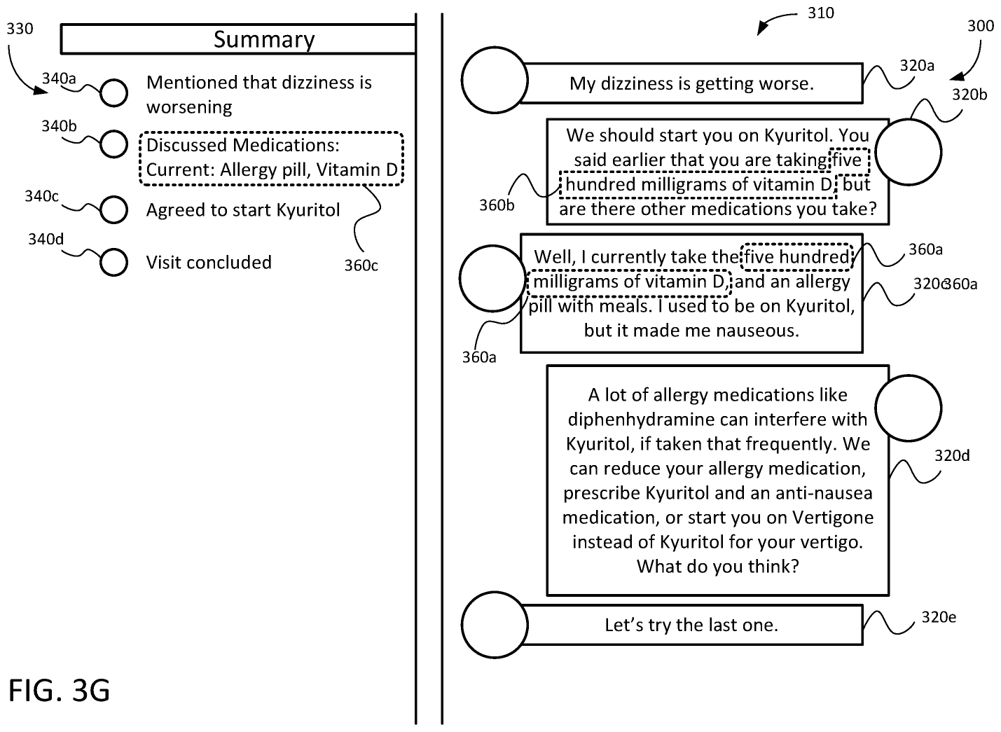

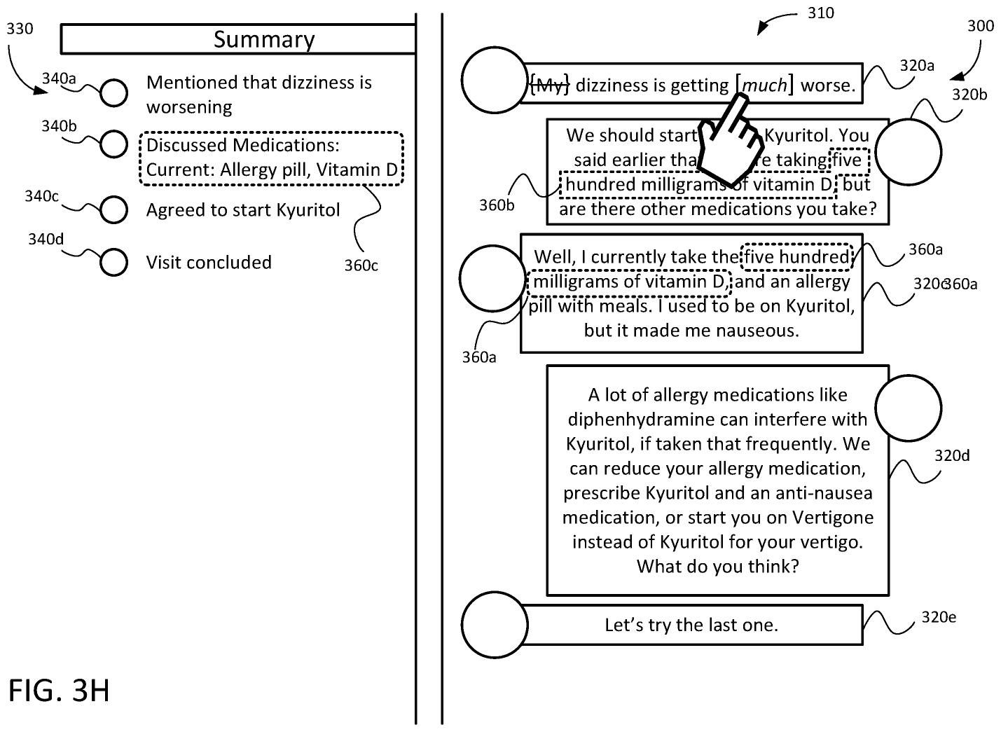

FIGS. 3A-3H illustrate interactions with a Graphical User Interface (GUI) 300 for an annotator showing an editing process for a transcript of a conversation, according to embodiments of the present disclosure. Using a conversation between a doctor and a patient as a non-limiting example, the GUI 300 illustrated in FIGS. 3A-3H shows a perspective for an annotator adapted interface, but in various embodiments, other conversations may relate to different conversational domains taken from different perspectives than those illustrated in the current example.

FIG. 3A illustrates a first state of the GUI 300, as may be provided to an annotator after initial analysis of an audio recording of a conversation by an NLP system 120. The transcript is shown in a transcript window 310, which includes several segments 320a-320e (generally or collectively, segment 320) identified within the conversation. In various embodiments, the segments 320 may represent speaker turns in the conversation, sentences identified in the conversation, topics identified in the conversation, a given length of time in the conversation (e.g., every X seconds), combinations thereof, and other divisions of the conversation.

Each segment 320 includes a portion of the written text of the transcript 160, and provides a UI element that allows the user to access the corresponding audio recording, make edits to the transcript, zoom in on the text, and otherwise receive additional detail for the selected portion of the conversation. The transcript illustrated in FIGS. 3A-3H may represent an entire conversation or a portion of the transcript such that the GUI 300 may omit portions of the transcript from initial display. For example, the GUI 300 may initially display only the segments 320 from which key terms or candidate terms appear (e.g., to skip introductory remarks or provide a summary), with the non-displayed segments 320 being omitted from display (e.g., positioned “off screen” for later access), shown as thumbnails, etc.

In various embodiments, additional data or metadata related to the segment 320 (e.g., speaker, topic, confidence in written text accurately matching input audio, whether edited by a user) can be presented based on color or shading of the segment 320 or alignment of the segment 320 in the transcript window 310. For example, the first segment 320a, the third segment 320c, and the fifth segment 320e are shown as left-aligned versus the second segment 320b and the fourth segment 320d, which are shown as right-aligned, which indicates different speakers for the differently aligned segments 320. In another example, the third segment 320c is displayed with a different shading than the other segments 320, which may indicate that the NLP system is confident that human error is present in the third segment 320c, that the NLP system is not confident in the transcribed words matching the spoken utterance, or another aspect of the third segment 320c that deserves additional attention from the user.

Depending on the display area available to present the GUI 300, the transcript window 310 may include some or all of the segments 320 at a given time. Accordingly, although not illustrated, in various embodiments, the transcript window 310 may include various content controls (e.g., scroll bars, text size controls, etc.) to enable access to more content than can be legibly displayed at one time on the device outputting the GUI 300. For example, content controls can allow a user to scroll to currently off-screen elements, zoom in on elements below a size threshold or presented as thumbnails when not selected, or the like.

Outside of the transcript window 310, the GUI 300 displays a summary window 330 with one or more summarized representations 340a-d (generally or collectively, representation 340). The representations 340 provide summarizations of the key points extracted from the conversation and selectable controls that, in response to selection by a user, adjust the display of the segments 320a in the transcript window 310 to highlight the segments on which the selected representation 340 is based. Accordingly, the representations 340 allow for easy navigation of the transcript based on the extracted summaries.

FIG. 3B illustrates selection of a first phrase in the GUI 300. When a user, via input from one or more of a keyboard, pointing device, voice command, or touch screen, selects a text element in the GUI 300, the GUI 300 may update the display to include various editing interfaces 350a-d (generally or collectively, editing interface 350) or highlight related elements via various indicators 360a-d (generally or collectively, indicator 360) in the GUI 300 for the selected element. For example, when selecting the phrase “multigrain” in the first segment 320a, the GUI 300 updates to include an editing interface 350 in association with the selected phrase, which is highlighted via a first indicator 360a, to allow editing or further interaction with the underlying conversation.

In various embodiments, the GUI 300 displays various indicators 360a-c (generally or collectively, indicators 360) for the candidate terms in one or both of the transcript window 310 and the summary window 330. Depending on the underlying reason why the NLP system identified a given element for display with an indicator 360, and where the element is identified, the GUI 300 may display the indicators 360 with different colors, text effects, outline effect, animations, icons, or the like to indicate differences underlying the identified candidate terms or where the indicators 360 are displayed. For example, as illustrated in FIG. 3B, the first indicator 360a is provided to show that an annotator has outlined the phrase “multigrains”, whereas the second through fourth indicators 360b-d are shown in to outline the text identified by the MLM as sharing conversational context with the selected phrase with different text effects (e.g., a different outline type, boldface type, etc.) than the first indicators 360a, to differentiate the different reasons for highlighting text. Additionally, the GUI 300 can “lowlight” or otherwise deemphasize portions of the summaries and transcript displayed, such as by decreasing the contrast or size of deemphasized text, overlaying redacting lines, shifting the display of elements in the available screen space, or the like.

As illustrated, the editing interface 350 provides various information and tools to the annotator. For example, a suggestion field 352 provides one or more suggested alternatives for a selected phrase. As used herein, a phrase refers to a set of one or more words (and non-word vocalizations, such as verbal fillers like “uh”, coughs, laughing, etc.) that are included in the transcript, or offered as a replacement for other terms in the transcript. As illustrated in FIG. 3B, the suggested phrase to replace the selected phrase of “multigrains” with is “milligrams”. The GUI 300 in FIG. 3B additionally provides a second indicator 360b for surrounding context for the selected phrase and a third indicator 360c for context identified elsewhere in the conversation (e.g., in the second segment 320b) for the selected phrase. To highlight these phrases (or deemphasize other phrases), the GUI 300 can apply text effects (e.g., bold, strikethrough, underline, etc.), change font colors, change background colors (e.g., apply highlighting or redacting lines), apply animations, apply text boxes surrounding indicated text, or the like, and combinations thereof.

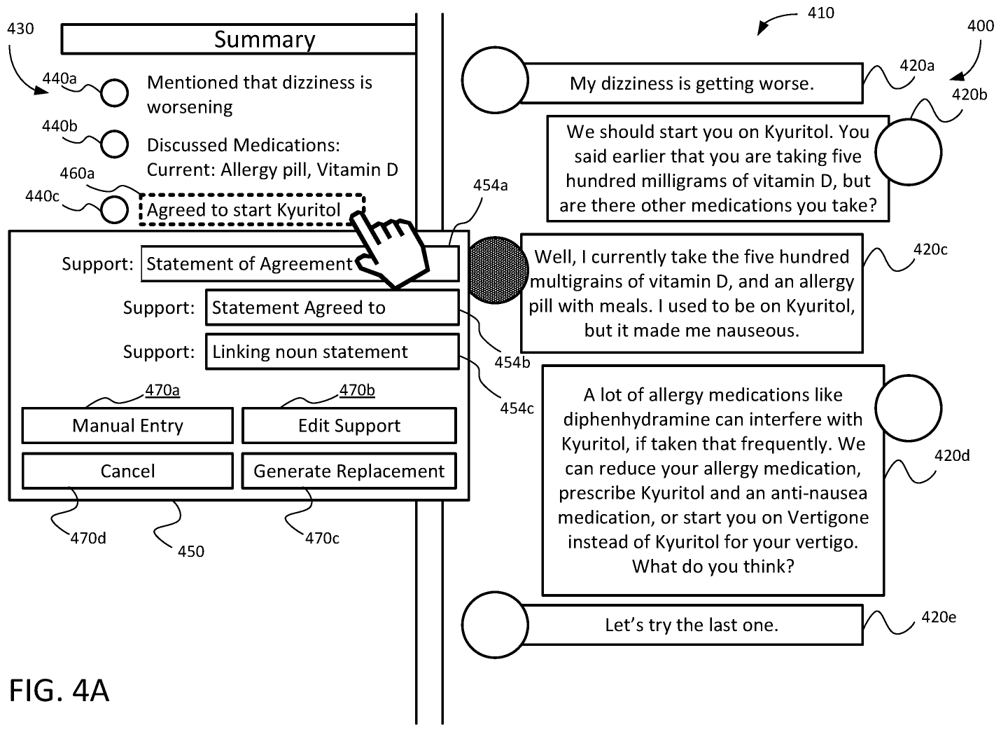

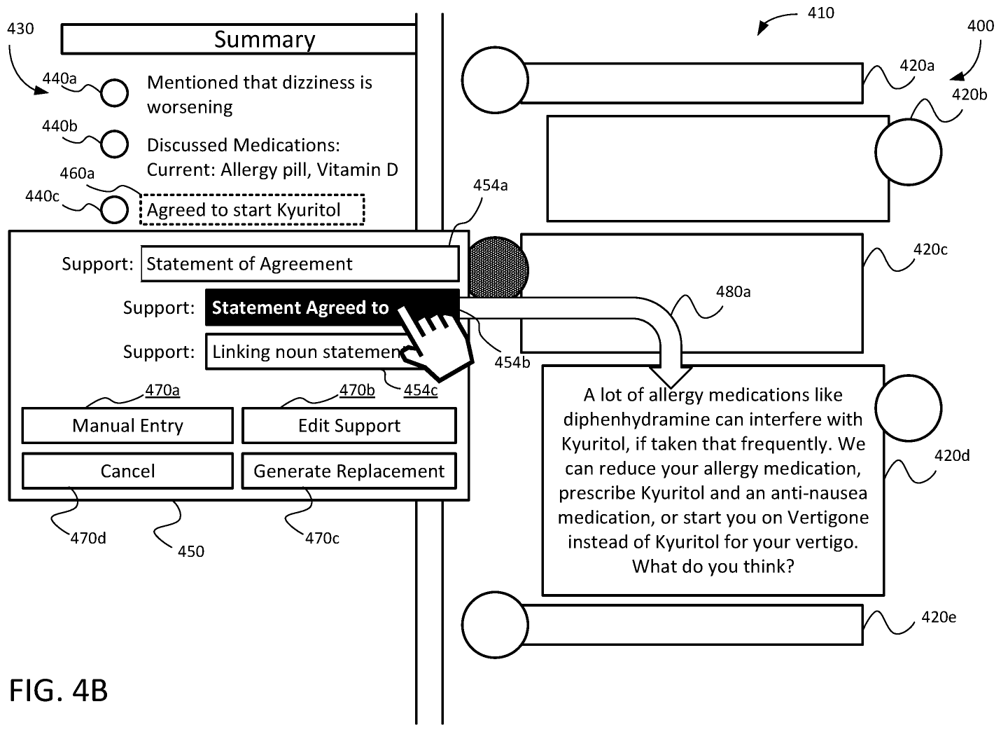

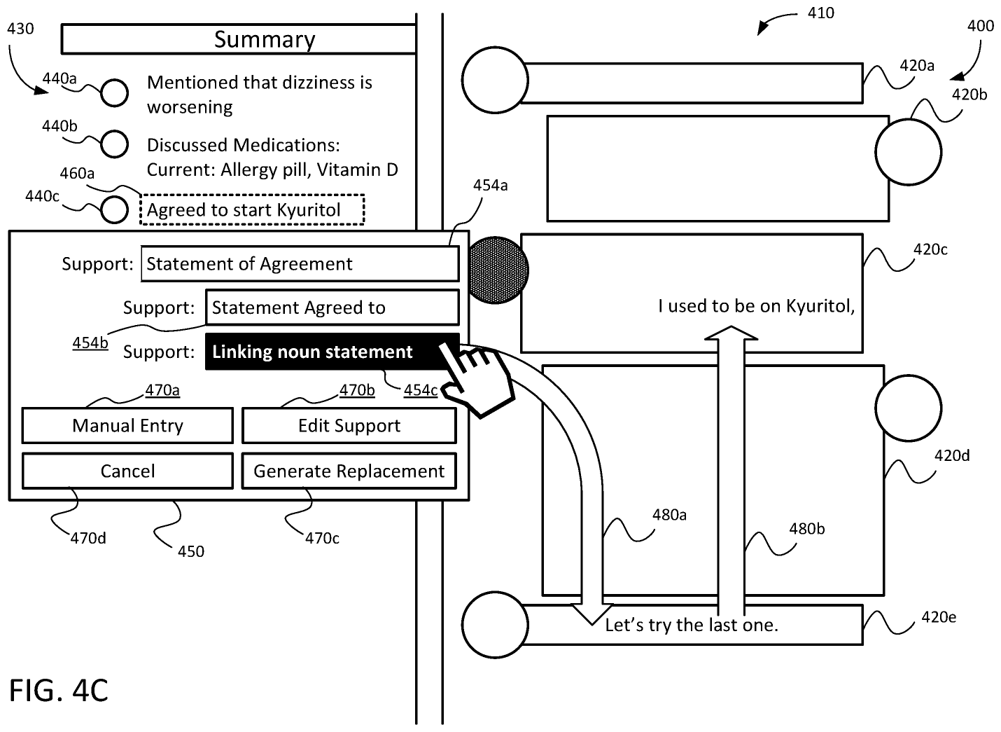

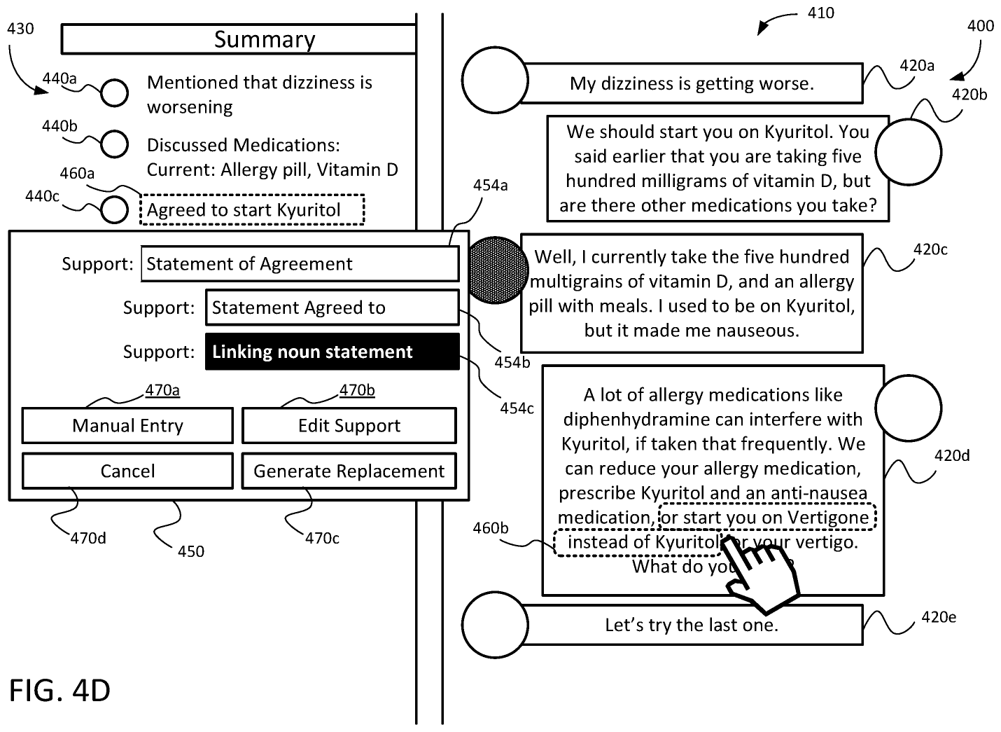

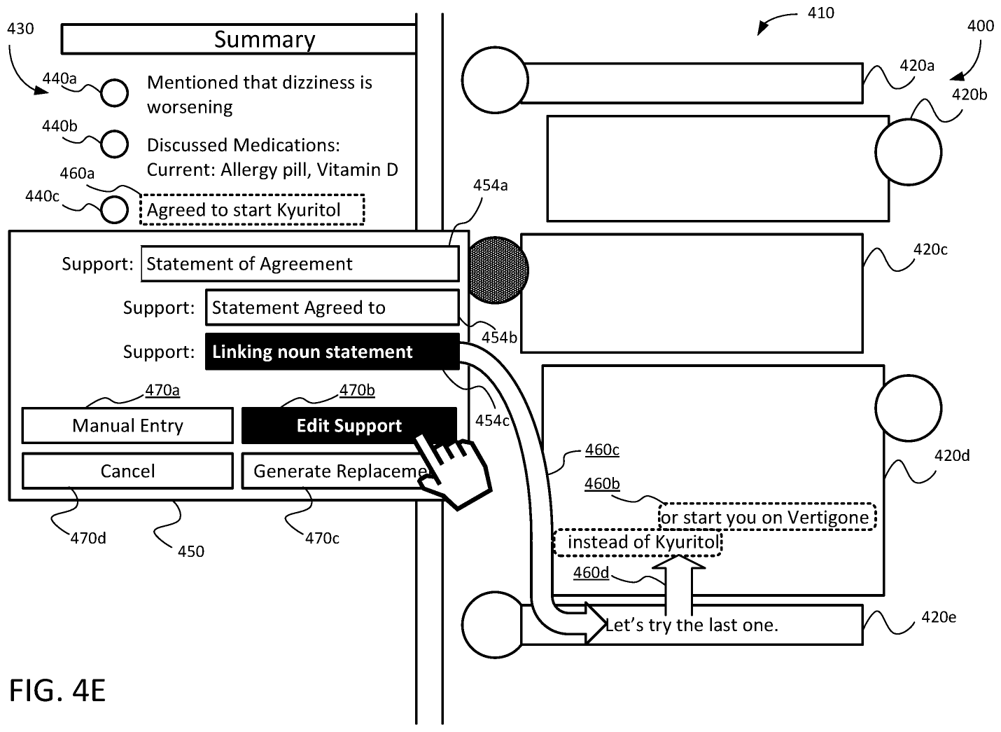

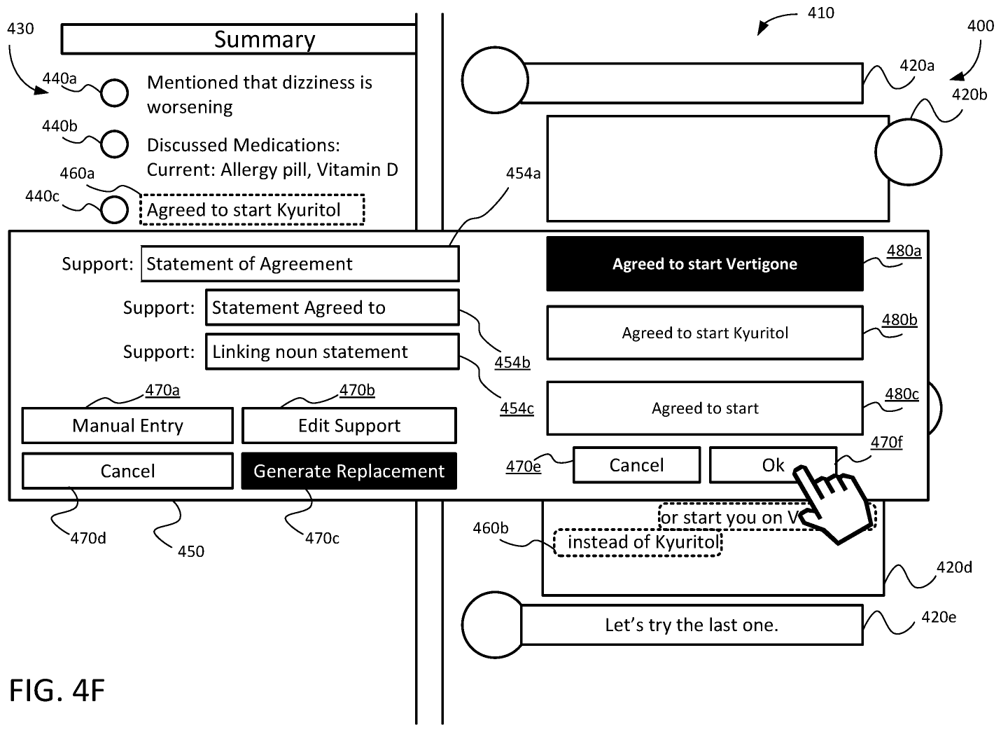

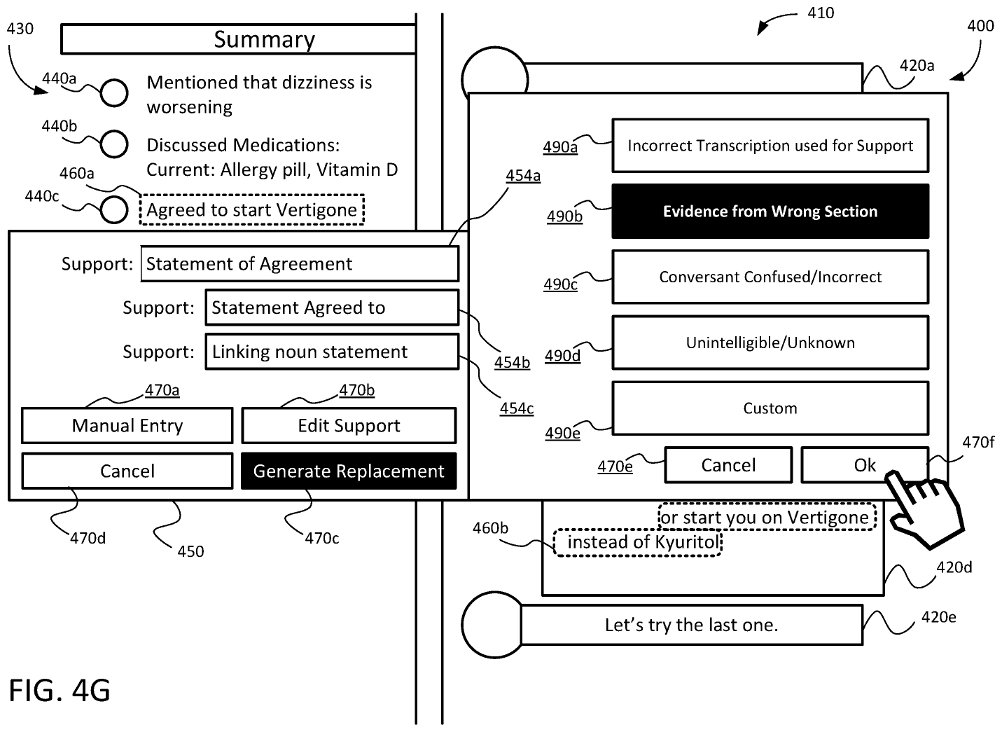

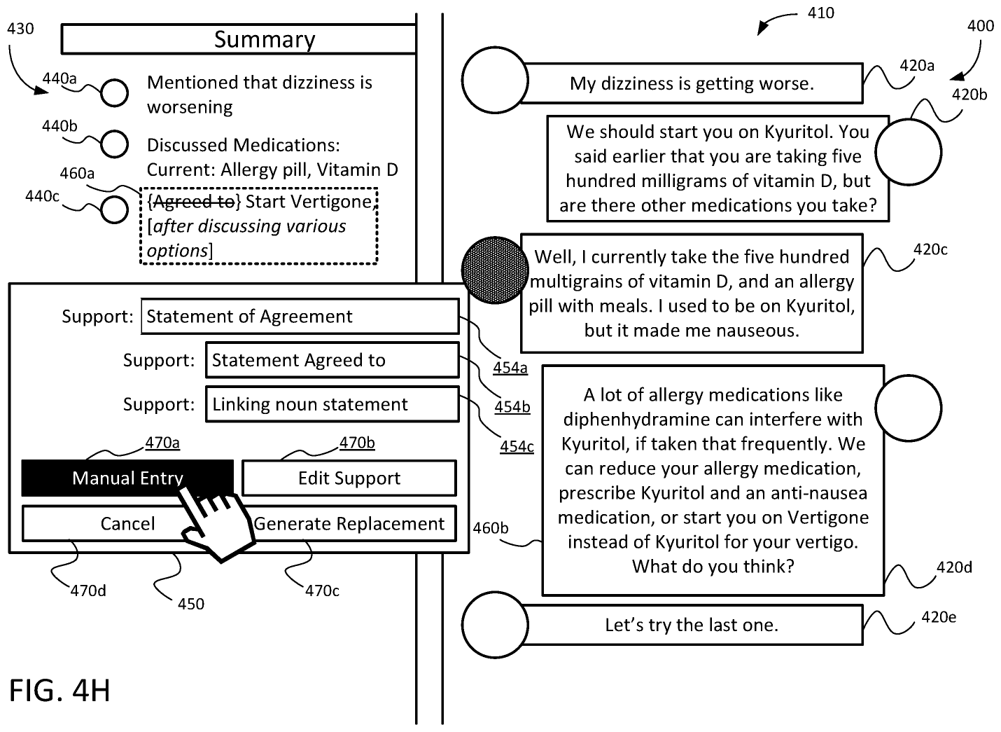

Additional controls 370a-h (generally or collectively, controls 370) included in the editing interface 350 can include (but are not limited to) a first control 370a to playback audio from the conversation associated with the selected phrase, a second control 370b to change the support type used to identify suggested phrases for a selected phrase, a third control 370c to add a note to the transcript (e.g., a comment or other metadata related to the conversation without altering the transcript thereof), a fourth control 370d to replace the selected phrase with a suggested phrase, a fifth control 370e to manually enter a replacement phrase for the selected phrase, and a sixth control 370f to cancel or otherwise dismiss the editing interface 350 without making an edit to the transcript. Although one implementation is shown in FIGS. 3A-4H, the present disclosure contemplates that other controls 370 for other functions, using different arrangements and control types are possible.

As illustrated, the editing interface 350 includes a support field 354 that indicates how the phrase(s) in the suggestion field 362 was/were determined, and a second control 370b to change the type of support used to determine the suggested phrase(s) shown in the suggestion field 362. For example, the support field in FIG. 3B illustrates that the suggestion of “milligrams” was selected to replace the selected phrase of “multigrains” based on “conversational context”. However, in response to the user selecting the second control 370b in FIG. 3C to change the type of support used to recommend the phrase, the suggestion field 362 updates to indicate that the suggested phrase should be “multigrains” according to the confidence of the MLM used to generate the transcript. In various embodiments, each of the options available via the support type control 370b may be cycled through (e.g., by successive toggles or presses of the second control 370b), selected from a dropdown list, chosen via radio buttons, chosen by a combination of checkboxes, or the like.

In various embodiments, each of the options selectable from the support type control 370b may correspond to one or a combination of one or more factors that the MLM used to generate the transcript from the spoken conversation used to evaluate what phrase to represent a set of phonemes from the spoken conversation. For example, the MLM may separately evaluate a best match for a set of phonemes to a dictionary of known words based on phonetic similarities, which may be further refined based on conversational context (e.g., adjusting the likelihood of a phrase occurring based on the presence of other phrases in the conversation), grammatical rules for the language being spoken (e.g., the terms their/there/they're/there're in English), known accents and speech patterns of the speakers (e.g., affecting the pronunciation and phrase choices), domain specific terminology (e.g., a conversation with an dairy farmer versus a gastroenterologist may affect whether an utterance is meant to be “lactose” versus “lactase”), and various other factors when determining what phrase to represent an utterance in a conversation. The MLM may use a learned weighting function of combine (or ignore) these various factors in combination, the annotator can view the highest output for each of these factors (or selected combination of factors) or the confidences of the MLM for several candidate phrases to represent the selected phrase. Accordingly, the annotator can query and identify why the MLM selected a given phrase to initially represent an utterance from a conversation before deciding how (or whether) to update that phrase, and is provided with candidate phrases considered (and potentially not initially selected by the MLM) to replace the initially selected phrase with.

For example, when the support type of “AI confidence” is selected, as in FIG. 3C, the annotator may see that the candidate phrase of “multigrains” was selected by the MLM to represent a corresponding utterance with 80% confidence. However, on selection of a control in the suggestion field 362, as in FIG. 3D, the GUI 300 presents the annotator with other candidate terms considered by the MLM with associated confidences in the result. As illustrated in FIG. 3D, the considered options include “multigrains” at 80% confidence, “mutations” at 12% confidence, milligrams” at 5% confidence, and “multi canes” and “mule; it grays” at less than 1% confidence.

As will be noted, the suggested “best” or highest confidence suggestion for the same selected phrase under the different support types selected in FIG. 3B and FIGS. 3C-3D is different. Accordingly, the annotator is able to identify how the MLM chose the initial phrase for inclusion in the transcript, and by agreeing with (or disagreeing with) a given support type as a reason for transcribing the conversation as initially presented, the annotator can provide feedback to the MLM to weight a given factor or combination of factors with greater or lesser emphasis when retaining the MLM.

Because transcripts of natural language conversations may include a variety of errors or unusual terminology that is not necessarily an error in transcription (e.g., an error on the part of the speaker, coined terms, domain specific use of a term with a different generalized meaning), the correction may need to be evaluated before being used to retrain the MLM model used to transcribe the conversation. Accordingly, in response to an annotator selection a third control 370c, as is shown in FIG. 3E, the editing interface 350 includes a plurality of notation options 390a-d (generally or collectively, option 390) to allow the annotator to add metadata to the transcript, and optionally provide training feedback to the MLM, in addition to or instead of replacing the phrase in the transcript. For example, when the annotator believed that the MLM properly transcribed an utterance from a speaker, but the speaker made an error, the annotator may add a note to the transcript and selectively leave the error in place or update the transcript to insert what the annotator believes the speaker to have intended. In the example shown in FIGS. 3A-3H, the speaker may have actually said “multigrains” as a Freudian slip when intending to say “milligrams”, which the annotator may leave in the transcript with a note indicating that “milligrams” was intended, the annotator may replace in the transcript with “milligrams” and add a note indicating that the speaker actually said “multigrains” via associated controls 370f-g.

In some cases, the annotator may wish to manually input a correct phrase when the MLM has not presented a suggestion that matches the annotator's understanding of the conversation, when the annotator believes that the correction is obvious (or manual input would be faster than using the tools provided by the MLM), or the like. Accordingly, the fifth control 370e provides the option for manual entry of a replacement phrase, so that when selected (as in FIG. 3F), the user is presented with a text entry field 356 in the editing interface 350 to type (e.g., via a hardware or software defined keyboard), enter text (e.g., via a stylus and gesture recognition), or otherwise enter specified text as a replacement for the selected phrase. In some embodiments, the editing interface 350 can include contextual fields 358a-b (generally or collectively, contextual fields 358) to provide preceding or following terms or phrases selected from the transcript. Similarly, in some embodiments, the text entry field 356 includes a grayscale or instructive text set 380 in for a suggested phrase that may be replaced with entered text 382 as the user types. This instructive text set 380 may initially be populated with a suggested phrase (e.g., chosen by the MLM according to one or more factors) to replace the selected phrase, but as the annotator inputs additional characters, the MLM may update the instructive text set 380 to remove characters already entered by the annotator (e.g., showing “ligrams” when the annotator has input “mil” to complete the phrase “milligrams”) and/or to update what phrase is suggested based on predictive text analysis (e.g., initially displaying “multigrains” as the instructive text set 380 but changing to display the remainder of “milligrams” after the annotator has entered at least “mi” as the entered text 382). In various embodiments, the instructive set 380 may be differentiated from the entered text 382 by one or more of: appearing on opposing sides of a cursor, different typefaces, different font effects, different colors, different type sizes, and combinations thereof.

Once an annotator has selected to add a note, to make an edit to the transcript, or to both add a note and make an edit to the transcript, the GUI 300 may update to display an indicator 360 for any downstream element that the MLM used the selected phrase for. As used herein, a “downstream element” refers to any output of the MLM model that used a specified element as an input. For example, as shown in FIG. 3H, because the MLM referenced the third segment 320c, from which the originally-selected phrase of “multigrains” appeared, to generate the second representation 340b of the discussed medications, the second representation 340b is considered a downstream reference relative to the third segment 320c. Similarly, if the MLM model used the phrase “five hundred milligrams of vitamin D” in the second segment 320 as a co-reference with the phrase “five hundred multigrains of vitamin D” in the third segment 320c to determine the context of the conversation and output a coherent and topically relevant transcript, each of the second segment 320b and the third segment 320c may be considered to be downstream elements of the other. Accordingly, in the example illustrated in FIG. 3G, the GUI 300 provides a first indicator 360a to highlight the updated phrase “five hundred milligrams of vitamin D” in the third segment 320c, a second indicator 360b to highlight the phrase five hundred milligrams of vitamin D″ in the second segment 320b. and a third indicator 360c in association with the second representation 340b and to draw the annotator's attention to portions of the transcript or summary that may need to be reviewed or updated based on any changes to the section just edited (e.g., the third segment 320c in the present example).

FIG. 4H illustrates an eighth state of the GUI 300 in which an annotator has added content and removed content from the first segment 320a. In various embodiments, the annotator can change the content shown in the segments by altering the phrases generated by the MLM (e.g., changing multigrains for milligrams per FIGS. 3D-3G) but can also add phrases that were not initially present and remove (without a replacement) phrases that were initially present.

For example, the annotator has removed the phrase “my” from the first segment 320a, which may be in response to the annotator reviewing the audio recording of the conversation to determine that the speaker did not say “my” or another word that should replace “my”. In other examples, the annotator may remove phrases from the transcript that the annotator deems to be irrelevant to the conversation (e.g., initial greetings, small talk, asides, interruptions, tangents, etc.) to reduce the amount of written record provided to an end-user. As illustrated, the removed text is indicated with surrounding braces and a strikethrough effect applied to the associated text, although other effects may be applied in other embodiments.

In the illustrated example, the annotator has added a phrase that the MLM model did not initially include in the transcript by adding the word “much” to the phrase in the first segment 320a, which may be in response to the annotator reviewing the audio recording of the conversation to determine that the speaker said “much” but the MLM did not detect the utterance or could not interpret what was said. In other examples, the annotator may add phrases to the transcript that the annotator deems to be relevant to the conversation (e.g., to add clarity where the spoken conversation is ambiguous, refers to removed content, or add context to a statement or question) to improve the readability of the transcript to the end-user. As illustrated, the added text is indicated with surrounding brackets and an italic effect applied to the associated text, although other effects may be applied in other embodiments.

FIGS. 4A-4H illustrate interactions with UIs for an annotator showing an editing process for a summary of a transcript of a conversation, according to embodiments of the present disclosure. Using a conversation between a doctor and a patient as a non-limiting example, the GUI 400 illustrated in FIGS. 4A-4H shows a perspective for an annotator adapted interface, but in various embodiments, other conversations may relate to different conversational domains taken from different perspectives than those illustrated in the current example.

FIG. 4A illustrates a first state of the GUI 400, as may be provided to an annotator after initial analysis of an audio recording of a conversation by an NLP system 120. The transcript is shown in a transcript window 410, which includes several segments 420a-420e (generally or collectively, segment 420) identified within the conversation. In various embodiments, the segments 420 may represent speaker turns in the conversation, sentences identified in the conversation, topics identified in the conversation, a given length of time in the conversation (e.g., every X seconds), combinations thereof, and other divisions of the conversation.

Each segment 420 includes a portion of the written text of the transcript 160, and provides a UI element that allows the user to access the corresponding audio recording, make edits to the transcript, zoom in on the text, and otherwise receive additional detail for the selected portion of the conversation. The transcript illustrated in FIGS. 4A-4H may represent an entire conversation or a portion of the transcript such that the GUI 400 may omit portions of the transcript from initial display. For example, the GUI 400 may initially display only the segments 420 from which key terms or candidate terms appear (e.g., to skip introductory remarks or provide a summary), with the non-displayed segments 420 being omitted from display (e.g., positioned “off screen” for later access), shown as thumbnails, etc.

In various embodiments, additional data or metadata related to the segment 420 (e.g., speaker, topic, confidence in written text accurately matching input audio, whether edited by a user) can be presented based on color or shading of the segment 420 or alignment of the segment 420 in the transcript window 410. For example, the first segment 420a, the third segment 420c, and the fifth segment 420e are shown as left-aligned versus the second segment 420b and the fourth segment 420d, which are shown as right-aligned, which indicates different speakers for the differently aligned segments 420. In another example, the third segment 420c is displayed with a different shading than the other segments 420, which may indicate that the NLP system is confident that human error is present in the third segment 420c, that the NLP system is not confident in the transcribed words matching the spoken utterance, or another aspect of the third segment 420c that deserves additional attention from the user.

Depending on the display area available to present the GUI 400, the transcript window 410 may include some or all of the segments 420 at a given time. Accordingly, although not illustrated, in various embodiments, the transcript window 410 may include various content controls (e.g., scroll bars, text size controls, etc.) to enable access to more content than can be legibly displayed at one time on the device outputting the GUI 400. For example, content controls can allow a user to scroll to currently off-screen elements, zoom in on elements below a size threshold or presented as thumbnails when not selected, or the like.

Outside of the transcript window 410, the GUI 400 displays a summary window 430 with one or more summarized representations 440a-d (generally or collectively, representation 440). The representation 440 provide summarizations of the key points extracted from the conversation and selectable controls that, in response to selection by a user, adjust the display of the segments 420a in the transcript window 410 to highlight the segments on which the selected representation 440 is based. Accordingly, the representation 440 allow for easy navigation of the transcript based on the extracted summaries.

In the illustrated examples in FIG. 4A-4H, however, the third representation 440c has been selected by an annotator as potentially not matching or accurately summarizing a key point from the conversation. For example, the MLM has indicated that the patient has agreed to start a course of Kyuritol, while the conversation may be interpreted by a human reader to indicate that the patient has agreed to start a course of Vertigone. In response to an annotator selecting the third representation 440c, the GUI 400 updates to display a first indicator 460a to highlight the third representation 440c, and an editing interface 450 to aid the annotator in reviewing and potentially editing the summary included in the third representation 440c.

As illustrated, the editing interface 450 includes several controls 470a-f (generally or collectively, controls 470), which can include (but are not limited to) a first control 470a to initiate manual entry of a replacement summary, a second control 470b to edit the support used by the MLM to generate the summary, a third control 370c instruct the MLM to generate a replacement summary, and a fourth control 370d to cancel or otherwise dismiss the editing interface 450 without making an edit to the summary. As shown in FIG. 4H, a fifth control 470e is provided to cancel entering feedback data, and a sixth control 470f is provided to accept entry of feedback data for why a new summary is being requested. Although one implementation is shown in FIGS. 4A-4H, the present disclosure contemplates that other controls 470 for other functions, using different arrangements and control types are possible.

As illustrated, the editing interface 450 includes several support fields 454a-c (generally or collectively, support field 454) that indicate how MLM came to the conclusion summarized in the representation 440 selected by the annotator. In various embodiments, the support fields 454 may be arranged hierarchically to demonstrate relationships between the contents of the support fields 454. For example, as shown in FIGS. 4A-4H, the first support field 454a shows that the support for the summary of “Agreed to start Vertigone” is based on a statement of agreement found in the transcript, and is further supported by the statement that was agreed to (indicated in the second support field 454b) and a linking noun statement (indicated in the third support field 454c) indicating what was agreed to.

FIG. 4B illustrates selection of the second support field 454b by the annotator, which the GUI 400 responds to by displaying a second indicator 460b to demonstrate where the support indicated in the selected support field 454 (e.g., the select support field 454b) was found by the MLM. As illustrated, the second indicator 460b points from the second support field 454b of “statement agreed to” to the text of the third segment 420c of the transcript, to indicate that the MLM identified that the “statement agreed to” is contained in the third segment 420c. Accordingly, the annotator can verify where the MLM gathered data or evidence to support the assertion that the speaker agreed to a given statement. If the annotator agrees with the MLM's selection of evidence, the annotator may leave the transcript or selection of evidence therefrom unedited.

FIG. 4C illustrates selection of the third support field 454c by the annotator, which the GUI 400 responds to by displaying a second indicator 460b and a third indicator 460c to demonstrate where the support indicated in the selected support field 454 (e.g., the select support field 454c) was found by the MLM. As shown in FIG. 4C, the statement of agreement in the fifth segment 420e of the transcript of “Let's try the last one” includes a noun linking statement for what is meant by “the last one”, which the GUI 400 identifies that the MLM identified as an agreement via the second indicator 460b and to refer to the speaker previously stating that “I used to be on Kyuritol” as “the last one” via the third indicator 460c. In this example, the MLM has identified the linked noun in a manner that is (somewhat) logical, but incorrect to a human speaker. For example, the MLM may have interpreted “the last one” to refer to the prescription that the speaker last had, while the annotator “the last one” to refer to the last option listed by the speaker of the fourth segment 420d.

Accordingly, FIG. 4D shows the annotator selecting what text that the MLM should use instead of what was originally selected by the MLM as support. A second indicator 460b shows the text from the fourth segment 420d that the annotator has selected to replace the text initially selected by the MLM. When the annotator selects the second control 470b to edit the support, as in FIG. 4E, the GUI 400 displays a third indicator 460c demonstrating where the support indicated in the selected support field 454 (e.g., the select support field 454c) should be found by the MLM, and a fourth indicator 460d showing how the noun phrase “the last one” should be interpreted. As illustrated in FIG. 4E, the annotator has selected the second control 470b and the third support field 454c to indicate that the statement of agreement of “let's try the last one” now uses the annotator-identified support of “the last one” to refer to the last element recited in the previous segments 420 of “or start you on Vertigone instead of Kyuritol” instead of the initially selected (by the MLM) phrase of “I used to be on Kyuritol”. In addition to alternatively to selecting replacement text in the transcript, the annotator may drag and drop the indicators 460 in some embodiments to point to or otherwise identify different support in the transcript.

Once the annotator has the identified new or different support from the transcript to use, the annotator may select the third control 470c to instruct the MLM to generate a replacement summary based on the updated evidence/support. In response, the annotating device queries the MLM with the updated support and requests one or more alternative summaries to use. The GUI 400 displays these one or more alternative summaries 480a-c (generally, or collectively alternative summary 480) for the annotator to select between, or use as a starting point for manual entry of an updated summary. For example, FIG. 4F shows the 450 including a first alternative summary 480a including text generated by the MLM using the updated support of “Agreed to start Vertigone”, a second alternative summary 480b including text generated by the MLM using the updated support of “Agreed to start Kyuritol”, and a third alternative summary 480b including text generated by the MLM using the updated support of “Agreed to start”, which may be used as a starting point for the annotator to manually enter the rest of the summary. In various embodiments, more or fewer alternative summaries 480 may be supplied from the MLM and displayed in the GUI 400, and the various alternative summaries 480 may be ordered based on confidence, difference from the initial summary, and various other criteria set by an annotating user.

In various embodiments, in response to the annotator selecting a sixth control 470f to replace an initial summary with a selected alternative summary 480 (e.g., the first alternative summary 480a in FIG. 4F), the annotating device updates the summary (e.g., locally and in a remote repository) and displays the update summary. For example, in FIG. 4G, the first indicator 460a draws attention to the third representation 440c now showing the summary as “Agreed to start Vertigone” instead of the initial summary of “Agreed to start Kyuritol”.

Additionally, in some embodiments, the editing interface 450 includes a plurality of notation options 490a-d (generally or collectively, option 490) to allow the annotator to add metadata to the summary, and optionally provide training feedback to the MLM, in addition to or instead of replacing the phrase in the summary. For example, when the annotator believes that the MLM properly transcribed an utterance from a speaker, but selected the wrong portion of the transcript to base a summary of the transcript off of, the annotator may add a note to the summary that evidence from the wrong section was used. In another example, when the annotator believes that the MLM improperly transcribed an utterance from a speaker, but selected the correct portion of the transcript to base a summary of the transcript off of, the annotator may add a note to the summary that an improper transcription was used to base the initial summary off of. These annotations may be used by the MLM during training to identify different layers or sub-MLMs to retrain or what data to use in a retraining process.

FIG. 4H illustrates use of the manual entry option, which may be used to supplement a newly generated response from the MLM (as is illustrated) or to forego use of MLM generated suggestions. As illustrated, the annotator has edited the updated summary in the third representation 440c. The first indicator 460a displays text removed by the editor between braces with a strikethrough effect, and text added by the annotator between brackets with an italic effect, although other effects may be used in other embodiments to indicate removed or added text.

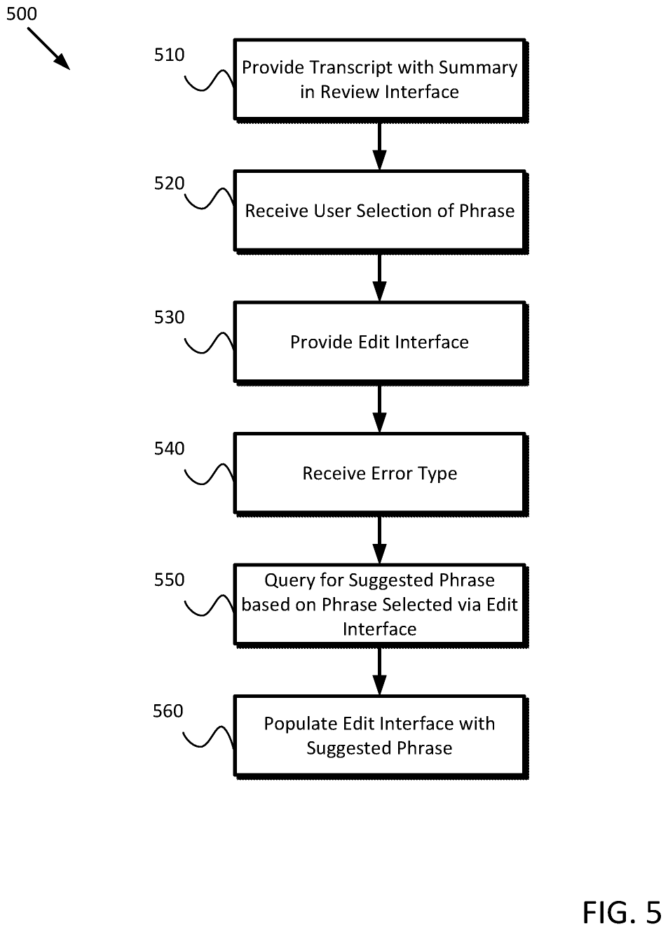

FIG. 5 is a flowchart of an example method 500 for providing annotating UIs, according to embodiments of the present disclosure. Method 500 begins at block 510, where an annotating device provides a GUI that includes a transcript of a natural language conversation and a summary of the natural language conversation that is based on a transcript and was generated by an MLM. The transcript and summary may be provided in various arrangements depending on the contents of the conversation, the end user of the conversation (e.g., doctor vs. patient vs. caretaker for the same conversation), the form factor of the consuming or annotating device used to view the transcript and UI, etc., of which FIGS. 3A-4H provide non-limiting examples.

In various embodiments, the summary can summarize the transcript as a whole or may include several sub-summaries of specific segments or aspects of the natural language conversation. For example, a summary of a lecture given by a professor to a student may include condensed versions of key topics brought up by the professor, paired questions (from the student) and answers (from the professor), listings of homework assignments, or the like. In another example, a summary of a visit with a doctor may be organized as a SOAP (subjective, objective, assessment, plan) note that divides relevant portions of the conversation into the corresponding categories for review. In another example, a summary may include a list of key terms and topics of the first X minutes of the conversation, a list of key terms and topics for the second X minutes of the conversation, a list of key terms and topics for the third X minutes of the conversation, etc. These summaries are generated by an MLM according to the specifications of the end user and the contents of the transcript. In various embodiments, the MLM used to generate the summaries may be part of the same NLP system or a different NLP system as a model used to transcribe the conversation.

At block 520, the UI receives user selection of a phrase (e.g., the selected phrase) in the transcript or summary to potentially edit. In various embodiments, the user selection may be part of an edit command that indicates the selected phrase in the transcript or in the summary, which may be one or more words in length, and may be selected via mouse, stylus, voice command, keyboard command, or the like. In various embodiments, in response to receiving a selection of the selected phrase in the summary, the annotating device highlights a portion of the transcript used by the MLM to generate the selected phrase. Additionally or alternatively, in response to receiving a selection of the selected phrase, the annotating device highlights matching instances of the select phrase occurring elsewhere in the transcript, summary, or both.

At block 530, in response to receiving the user selection of the selected phrase (per block 520), the annotating device provides an edit interface in the GUI. In various embodiments, the edit interface is positioned in the GUI as a sub-window (either modal or non-modal) to allow the annotator to continue seeing the selected phrase, but may overlay other portions of the GUI. Additionally, the GUI may highlight (or deemphasize) various portions of the transcript and summary to identify relations between the selected phrase and other elements of the conversation or draw the annotator's attention to certain elements.

At block 540, when the annotator indicates an error type suspected for the selected phrase, the annotating device may add a note to the summary or transcript, indicate the error type to the MLM that was used to generate the summaries and transcript, or both. For example, when an annotator indicates that an error in the transcript was an error on the speaker's part, the annotator may correct the transcript to correct the misspoken phrase and indicate to the MLM that the MLM should not retrain on the error (as the error was not the fault of the MLM). In another example, when an annotator indicates that an error in the transcript was an error on the speaker's part, the annotator may leave the transcript uncorrected and instead add a note for the reader for an intended phrase while leaving the misspoken phrase in the transcript without transmitting or otherwise indicating the error to the MLM. In another example, when an annotator indicates that an error in the transcript was an error on the speaker's part, the annotator may leave the transcript uncorrected and instead add a note for the reader for an intended phrase while leaving the misspoken phrase in the transcript, but indicates the correct phrase to the MLM to identify potentially affected downstream phrases that uses the incorrect phrase as an input (e.g., summarizing the transcript with the incorrect phrase). In some embodiments, when correcting an error, the annotator may indicate different error types for the correction that may affect the suggestions that the MLM returns or whether the MLM adjusts downstream processes. For example, when the selected phrase is to be replaced based on an error in transcription, the MLM may provide a tailored correction for a suggested phrase that ranks candidate replacement phrases according to a different set of factors used to produce the initial phrase (e.g., changing a weighting) or return the second-best candidate phrases to the annotator to choose from. In another example, when the annotator indicates that the MLM generated a summary based on an incorrect piece of evidence (e.g., selecting the wrong noun to correspond to a pronoun), the tailored correction may be an updated summary generated using a different piece of evidence indicated by the annotator.

At block 550, the annotating device queries the MLM that was used to generate the summaries and transcript for a suggested phrase to replace the selected phrase with. In various embodiments, the annotating device may receive suggested phrases from the MLM that indicate various criteria or factors used to evaluate the suggestions, which the annotator may filter locally to receive an appropriate suggested phrase with which to replace the selected phrase. Accordingly, the annotating device may send to the MLM, as part of the query, the selected phrase (or locational information for where the selected phrase occurs in the transcript or recording of the conversation) and one or more error types that the selected phrase is believed to display.

In various embodiments, the MLM may generate the suggested phrase from a re-analysis of the transcript or recorded conversation, or may return the suggested phrase from a list of candidate phrases considered by the MLM when initially generating the transcript and summary. In various embodiments, the re-analysis takes into consideration any edits or annotations already maybe by the annotator to any of the transcript or summary. For example, the MLM may return the phrase with the second highest confidence to represent an utterance from the initial analysis used to generate the transcript/summary when the selected phrase had the highest confidence to initially represent the utterance in the transcript/summary. In another example, the MLM may reanalyze the transcript to generate a list of candidate phrases to represent an utterance, such as when the annotator previously edited a phrase that is used as an input for the currently selected phrase.

In various embodiments, because the MLM may be configured to generate the suggestions based solely on the context of the currently defined transcript (e.g., rather than past annotator actions in or terminology found in other transcripts), edits to the transcript may have an outsized effect on other sections of the transcript so that similar terminology is used throughout the transcript and summary and the MLM provides suggested phrases selected based on the current context of the transcript being annotated. Accordingly, the MLM provides the selected phrases using the vocabulary found in the transcript using context outside of the selected phrases. For example, in a suggested phrase for an updated summary section in response to an edit to the transcript of “follow-up on Thursday” to “follow-up on Tuesday”, the MLM may draw from outside of the selected or replacement phrases to generate a summary of “call back on Tuesday”; identifying that the follow-up action is to be performed by telephone (e.g., rather than email, text message, or in person visit) as stated elsewhere in the context of the present conversation.

Additionally, the MLM uses the vocabulary used elsewhere in the transcript to generate the suggestion for the updated portions of the summary or transcript to maintain consistency in terminology. Continuing the earlier example, after identifying that the follow-up action should be performed by phone, the MLM may represent the summary as “call back on Tuesday”, “phone back on Tuesday”, “telephonic follow-up on Tuesday” as valid and accurate summaries of the conversation, but generates the summary using the vocabulary and terminology used by the speakers so that the summaries more closely match the word choices made by the speakers.

At block 560, the annotating device populates the edit interface with a suggested phrase received from the MLM responsive to the query sent in block 550. In various embodiments, the MLM may respond with more than one suggested phrase, and may include additional indicia related to the selection process for each of the suggested phrases. These data may be formatted in a markup language document (e.g., XML, JSON, HL7, and FHIR) or other structured data format to relate the various suggested phrases, indicia, and filtering criteria in a manner that the annotating device can use to format display of the suggested phrases received from the MLM per the user preferences of the annotator.

For example, the edit interface may display the suggested phrase as a single option on a button or action field to replace the initially selected phrase, in a drop down menu with other suggested phrases for an annotator to choose between, in a text entry field as non-selectable text that is replaced as the annotator manually enters a replacement, as an overlay or redline addition/replacement for the selected phrase, etc.

In various embodiments, the suggested phrase may include more or fewer of words than the selected phrase. For example, when editing a transcript with a selected phrase of “inside out”, the MLM may provide suggested phrases of “inns I doubt” (more words), “insolent” (fewer words), “in stout” (same number of words).

Each of these suggested phrases may include indicia of the confidence that the MLM has in the suggested phrase correctly representing an associated portion of the spoken conversation according to various metrics. For example, each of the suggested phrases of “inside out”, “inns I doubt”, “insolent”, and “in stout” may be associated with confidence scores for phonetic similarity of 80%, 78%, 50%, and 88% (respectively) and confidence scores for semantic relatedness of 93%, 15%, 20%, and 75% (respectively) based on the other phrases selected for inclusion in the transcript. Additionally, the MLM may include the weightings used for each of the factors in a combined analysis. (e.g., the phonetic similarity factor is given X weight when analyzed with the semantic relatedness factor, which is given weight Y).

In various embodiments, the annotating device may populate the edit interface with the suggested phrases according to the confidence scores and/or user settings. For example, the user settings may request the suggestions with confidence scores above threshold Y for factor Z, the top X suggestions for factor Z, a combination of confidences for combined factors Z₁ and Z₂, etc. The confidence scores may be output for display to the annotator, or may be used to rank the potential suggested phrases to display without providing a numerical output.

Example method 500 may then conclude.

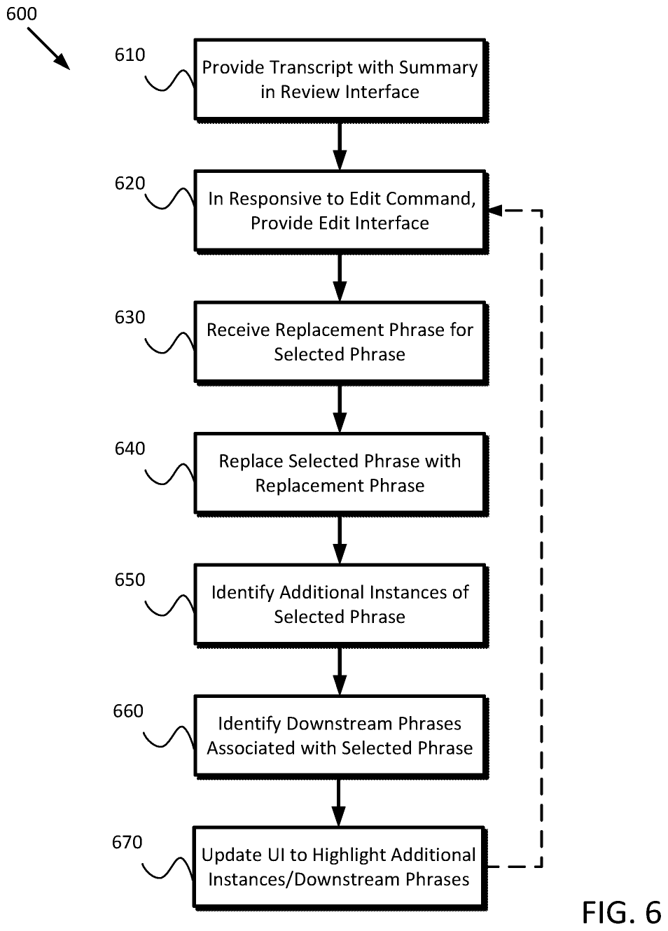

FIG. 6 is a flowchart of an example method 600 for providing annotating UIs, according to embodiments of the present disclosure. Method 600 begins at block 610, where an annotating device provides a GUI that includes a transcript of a natural language conversation and a summary of the natural language conversation that is based on a transcript and was generated by an MLM. The transcript and summary may be provided in various arrangements depending on the contents of the conversation, the end user of the conversation (e.g., doctor vs. patient vs. caretaker for the same conversation), the form factor of the consuming or annotating device used to view the transcript and UI, etc., of which FIGS. 3A-4H provide non-limiting examples.

At block 620, in response to receiving an edit command referencing a selected phrase in the transcript or summary, the annotating device provides an edit interface in the GUI. The edit command may include user selection of a phrase while in an editing mode or initiation of an editing mode after user selection of the phrase when in another mode (e.g., a drafting mode, a reading mode, etc.). For example, an annotator in the editing mode may be provided with the edit interface related to a phrase in direct response to selecting that phrase, while an annotator in a reading or drafting mode may select a phrase and not be provided with the edit interface until initiating a separate edit command (e.g., a keyboard shortcut, clicking a pop-up GUI element, etc.) that switches to the edit mode and requests provision of the edit interface for the selected phrase.

In various embodiments, the edit interface is positioned in the GUI as a sub-window (either modal or non-modal) to allow the annotator to continue seeing the selected phrase, but may overlay other portions of the GUI. Additionally, the GUI may highlight (or deemphasize) various portions of the transcript and summary to identify relations between the selected phrase and other elements of the conversation or draw the annotator's attention to certain elements.

At block 630, the annotating device receives a replacement phrase for the selected phrase. In various embodiments, the replacement phrase may be a suggested phrase received from the MLM used to generate one or both of the transcript and summary, a manually entered phrase from the annotator, or a combination thereof.

At block 640, the annotating device replaces the selected phrase with the replacement phrase. In various embodiments, the replacement is made to a local copy of the transcript/summary, which is later uploaded to a database from which other users can access the transcript/summary, while in other embodiments, the replacement is made to a “live” version of the transcript/summary via a network connection between the annotating device and the database from which the transcript/summary are accessed.

At block 650, the annotating device identifies additional instances of the selected phrase (if any) in the transcript and summary. In various embodiments the matching algorithm used by the annotating device may include exact matches as well as fuzzy matches. For example, when the selected phrase was “calibrating your pacemaker,” the annotating device may identify other exact matches of “calibrating your pacemaker” as well as phrases that include different conjugations, gerunds, and nominalizations of the key terms of “calibrate” and “pacemaker” and different auxiliary identifiers from “your” to identify “calibrated my old pacemaker”, “calibrate pacemaker”, “pacemaker calibration”, and “going to calibrate this pacemaker” as fuzzy matches to the key terms found in the selected phrase. The present disclosure contemplates various fuzzy matching algorithms with different criteria may be used by the annotating device to identify additional instances of the selected phrase.

At block 660, the annotating device identifies downstream phrases associated with the selected phrase. In various embodiments, the MLM when supplying the suggested replacement phrase identifies the downstream phrases to the annotating device.

As used herein, a downstream phrase does not necessarily refer to a phrase that occurs later in a conversation, but rather refers to a phrase that was identified or generated using the selected phrase as an input. Although a later phrase in the transcript may be considered downstream from a given phrase, phrases that occur earlier in the transcript may also be considered downstream from the given phrase when the MLM uses a bidirectional analysis of the conversation to identify or clarify how utterances should be interpreted. In a bidirectional analysis, the MLM may initially transcribe a first utterance that occurs at time tₓ and a second utterance that occurs at time t_{x+y} in the conversation, but uses the transcription of the second utterance as context for how to transcribe the earlier-occurring first utterance.

Additionally, phrases outside of the transcript (e.g., in the summary) may also be downstream phrases from phrases that occur in the transcript. For example, a summary of “agreed to call back on Monday” uses portions of the transcript as inputs to identify that an agreement was reached, that the agreed upon action was to call someone back, and that the action should take place on Monday. If any of the phrases used to identify these components of the summary were edited, the summary may no longer correctly match as it is a downstream phrase from each of the component phrases.

In various embodiments, the MLM may identify the downstream phrases according to a relevancy score threshold so that a subset of the potential downstream phrases are identified to the annotating devices as being downstream from the selected phrase. For example, when the annotating device uses the replacement phrase to replace the selected phrase in the transcript, the MLM can identify updated portions or segments for affected (e.g., downstream) summaries to replace an initial portion of the summary that used the (now-replaced) selected phrase as a basis for that summary.

At block 670, the annotating device updates the editing UI to highlight the additional instances (identified per block 650) and the downstream phrases (identified per block 660) to the selected phrase that was replaced. Accordingly, the annotator's attention may be drawn to the phrases that are potentially affected by the replacement of the selected phrase. The annotator may then select these highlighted phrases for further correction, and return method 600 to block 620 to edit a newly selected phrase. Otherwise, method 600 may then conclude.

FIG. 7 illustrates physical components of an example computing device 700 according to embodiments of the present disclosure. The computing device 700 may include at least one processor 710, a memory 720, and a communication interface 730.

The processor 710 may be any processing unit capable of performing the operations and procedures described in the present disclosure. In various embodiments, the processor 710 can represent a single processor, multiple processors, a processor with multiple cores, Central Processing Units (CPUs), Graphical Processing Units (GPUs), and combinations thereof.

The memory 720 is an apparatus that may be either volatile or non-volatile memory and may include RAM, flash, cache, disk drives, and other computer readable memory storage devices, including memory that is included in a CPU or GPU. Although shown as a single entity, the memory 720 may be divided into different memory storage elements such as RAM and one or more hard disk drives. As used herein, the memory 720 is an example of a device that includes computer-readable storage media, and is not to be interpreted as transmission media or signals per se.

As shown, the memory 720 includes various instructions that are executable by the processor 710 to provide an operating system 722 to manage various features of the computing device 700 and one or more programs 724 to provide various functionalities to users of the computing device 700, which include one or more of the features and functionalities described in the present disclosure. One of ordinary skill in the relevant art will recognize that different approaches can be taken in selecting or designing a program 724 to perform the operations described herein, including choice of programming language, the operating system 722 used by the computing device, and the architecture of the processor 710 and memory 720. Accordingly, the person of ordinary skill in the relevant art will be able to select or design an appropriate program 724 based on the details provided in the present disclosure.

Additionally, the memory 720 can include one or more of machine learning models 726 for speech recognition and analysis, as described in the present disclosure. As used herein, the machine learning models 726 may include various algorithms used to provide “artificial intelligence” to the computing device 700, which may include Artificial Neural Networks, decision trees, support vector machines, genetic algorithms, Bayesian networks, or the like. The models may include publically available services (e.g., via an Application Program Interface with the provider) as well as purpose-trained or proprietary services. One of ordinary skill in the relevant art will recognize that different domains may benefit from the use of different machine learning models 726, which may be continuously or periodically trained based on received feedback. Accordingly, the person of ordinary skill in the relevant art will be able to select or design an appropriate machine learning model 726 based on the details provided in the present disclosure.

The communication interface 730 facilitates communications between the computing device 700 and other devices, which may also be computing devices 700 as described in relation to FIG. 7. In various embodiments, the communication interface 730 includes antennas for wireless communications and various wired communication ports. The computing device 700 may also include or be in communication, via the communication interface 730, one or more input devices (e.g., a keyboard, mouse, pen, touch input device, etc.) and one or more output devices (e.g., a display, speakers, a printer, etc.).

Accordingly, the computing device 700 is an example of a system that includes a processor 710 and a memory 720 that includes instructions that (when executed by the processor 710) perform various embodiments of the present disclosure. Similarly, the memory 720 is an apparatus that includes instructions that when executed by a processor 710 perform various embodiments of the present disclosure.

Programming modules, may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable user electronics, minicomputers, mainframe computers, and the like. Embodiments may also be practiced in distributed computing environments where tasks are performed by remote processing devices that are linked through a communications network. In a distributed computing environment, programming modules may be located in both local and remote memory storage devices.

Furthermore, embodiments may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Embodiments may also be practiced using other technologies capable of performing logical operations such as, for example, AND, OR, and NOT, including, but not limited to, mechanical, optical, fluidic, and quantum technologies. In addition, embodiments may be practiced within a general purpose computer or in any other circuits or systems.

Embodiments may be implemented as a computer process (method), a computing system, or as an article of manufacture, such as a computer program product or computer-readable storage medium. The computer program product may be a computer-readable storage medium readable by a computer system and encoding a computer program of instructions for executing a computer process. Accordingly, hardware or software (including firmware, resident software, micro-code, etc.) may provide embodiments discussed herein. Embodiments may take the form of a computer program product on a computer-usable or computer-readable storage medium having computer-usable or computer-readable program code embodied in the medium for use by, or in connection with, an instruction execution system.

Although embodiments have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage medium does not include computer-readable transmission media.

Embodiments described in the present disclosure may be used in various distributed computing environments where tasks are performed by remote processing devices that are linked through a communications network.

Embodiments described in the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 700 or any other computing devices, in combination with computing device 700, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described embodiments.

The descriptions and illustrations of one or more embodiments provided in this application are intended to provide a thorough and complete disclosure of the full scope of the subject matter to those of ordinary skill in the relevant art and are not intended to limit or restrict the scope of the subject matter as claimed in any way. The embodiments, examples, and details provided in this disclosure are considered sufficient to convey possession and enable those of ordinary skill in the relevant art to practice the best mode of the claimed subject matter. Descriptions of structures, resources, operations, and acts considered well-known to those of ordinary skill in the relevant art may be brief or omitted to avoid obscuring lesser known or unique aspects of the subject matter of this disclosure. The claimed subject matter should not be construed as being limited to any embodiment, aspect, example, or detail provided in this disclosure unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently.

Having been provided with the description and illustration of the present disclosure, one of ordinary skill in the relevant art may envision variations, modifications, and alternative embodiments falling within the spirit of the broader aspects of the general inventive concept provided in this disclosure that do not depart from the broader scope of the present disclosure.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

The following claims are not intended to be limited to the embodiments shown herein, but are to be accorded the full scope consistent with the language of the claims. Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

1. A method, comprising:
providing, via a graphical user interface (GUI), a transcript of a natural language conversation and a summary of the natural language conversation based on the transcript generated by a machine learning model;
in response to user selection of a selected phrase in the transcript, providing an edit interface in the GUI;
querying the machine learning model for a suggested phrase to replace the selected phrase with in the transcript; and
populating the edit interface with the suggested phrase.

2. The method of claim 1, further comprising:
receiving an error type for the selected phrase via the edit interface; and
wherein querying the machine learning model for the suggested phrase includes:
transmitting the selected phrase and the error type to the machine learning model to receive the suggested phrase as a tailored correction to the error type for the selected phrase.

3. The method of claim 1, wherein the suggested phrase is populated in a text entry field included in the edit interface as non-selectable text.

4. The method of claim 1, wherein the suggested phrase is presented in an action field in the edit interface, wherein a text entry field included in the edit interface is populated with the suggested phrase in response to receiving a selection of the action field.

5. The method of claim 1, wherein the machine learning model initially selected the selected phrase to represent a portion of the natural language conversation according to a highest confidence level out of a plurality of candidate phrases, and returns the suggested phrase based on the suggested phrase having a second highest confidence level out of the plurality of candidate phrases.

6. The method of claim 1, wherein the selected phrase includes more or fewer words than the suggested phrase.

7. The method of claim 1, wherein the suggested phrase is generated based on a context solely identified from within the transcript.

8. The method of claim 1, further comprising, in response to replacing the selected phrase in the transcript with a replacement phrase:
transmitting the replacement phrase to the machine learning model; and
receiving at least one updated section for the summary based on the replacement phrase replacing the selected phrase in the transcript; and
updating the summary according to the at least one updated summary section.

9. A method, comprising:
providing, via a graphical user interface (GUI), a transcript of a natural language conversation and a summary of the natural language conversation based on the transcript generated by a machine learning model;
in response to user selection of a selected phrase in the summary, providing an edit interface in the GUI;
querying the machine learning model for a suggested phrase to replace the selected phrase; and
populating the edit interface with the suggested phrase.

10. The method of claim 9, wherein the machine learning model initially selected the selected phrase to represent a portion of the natural language conversation according to a highest confidence level out of a plurality of candidate phrases, and returns the suggested phrase based on the suggested phrase having a second highest confidence level out of the plurality of candidate phrases.

11. The method of claim 9, wherein the machine learning model provides the selected phrase based on vocabulary found in in the transcript outside of the selected phrase.

12. The method of claim 9, further comprising:
in response to receiving a selection of the selected phrase in the summary, highlighting, in the GUI, a portion of the transcript used by the machine learning model to generate the selected phrase.

13. The method of claim 9, further comprising:
in response to replacing the selected phrase in the summary, identifying sections of the transcript matching the selected phrase.

14. The method of claim 9, wherein the selected phrase includes more or fewer words than the suggested phrase.

15. A method, comprising:
providing, via a graphical user interface (GUI), a transcript and a summary of a natural language conversation based on the transcript generated by a machine learning model;
in response to user selection of a selected phrase in one of the transcript and the summary, providing an edit interface in the GUI;
receiving, via the edit interface, a replacement phrase for the selected phrase in the one of the transcript and the summary;
replacing the selected phrase with the replacement phrase in the one of the transcript and the summary;
identifying any additional instances of the selected phrase in the transcript and the summary;
querying the machine learning model for downstream phrases in the transcript and the summary that used the selected phrase as an input; and
in response to there being at least one additional instance or downstream phrase, updating the GUI to highlight the at least one of the additional instances and the downstream phrases.

16. The method of claim 15, further comprising, in response to providing the edit interface:
querying the machine learning model that was used to generate the summary for a suggested phrase to replace the selected phrase; and
populating the edit interface with the suggested phrase.

17. The method of claim 15, wherein the downstream phrases included matching instances of the selected phrase and other phrases that were selected by the machine learning model to represent the natural language conversation based on initial identification of the selected phrase.

18. The method of claim 15, wherein at least one of the additional instances and the downstream phrases are provided in a different one of the summary and the transcript from where the selected phrase is provided.

19. The method of claim 15, wherein the replacement phrase replaces the selected phrase from the transcript, further comprising:
receiving updated portions of the summary from the machine learning model for initial portions of the summary that the machine learning model used the selected phrase as a basis for.

20. The method of claim 15, wherein the selected phrase includes at least two words.

21-60. (canceled)
